(19) United States
(12) Patent Application Publication
(10) Pub. No.: US 2025/0069281 A1
(43) Pub. Date: Feb. 27, 2025

(54) PREDICTION APPARATUS, PREDICTION METHOD, AND STORAGE MEDIUM FOR STORING PROGRAM

(71) Applicant: PROTERIAL, LTD., Tokyo (JP)

(72) Inventors: Toshiki Ishida, Tokyo (JP); Makoto Ono, Tokyo (JP)

(21) Appl. No.: 18/732,133

(22) Filed: Jun. 3, 2024

(30) Foreign Application Priority Data
Jun. 9, 2023 (JP) 2023-095375

(51) Int. Cl. G06T 11/00; G06T 3/4053

(52) U.S. Cl. CPC G06T 11/00; G06T 3/4053

(57) ABSTRACT

A prediction apparatus uses microstructure images acquired from a material as learning data to build a generative model for generating a microstructure image of the material, and, by learning data of process conditions paired with the microstructure images of the material, builds a process condition prediction model. The process condition prediction model is a regression model and is for predicting process conditions for any microstructure images. The prediction apparatus generates a microstructure image of a material by inputting sampled latent variables into the generative model, and enters the generated microstructure image of the material into the process condition prediction model so as to generate a microstructure image of a material and, at the same time, predict process conditions for the microstructure image.

### TECHNICAL FIELD

The present invention relates to a technique for supporting materials development.

### BACKGROUND OF THE INVENTION

In recent years, a field of technology called materials informatics for developing new materials by effectively utilizing information science, particularly data science, has been attracting attention. In materials informatics, relations are made between various data such as experimental conditions and results, and the data is accumulated in a database so as to extract useful information, by making full use of statistic analysis, machine learning, simulations and so on, for the development of new materials.

For example, Patent Documents 1 and 2 describe techniques for predicting process conditions of materials by making relations between process conditions, such as material composition conditions and heat treatment conditions, and material properties to learn a regression model, and to predict process conditions for the materials from desired material properties by using the regression model. The method in which a regression model is learned and generated as disclosed in Patent Documents 1 and 2 is highly accurate, and thus can be easily adapted to a field of material design that is based on numerical data.

### RELATED APPLICATIONS

[Patent Document 1] Japanese Patent No. 6617842
[Patent Document 2] Japanese Patent No. 6950119

### SUMMARY OF THE INVENTION

### Problems to be Solved by the Invention

However, there is a limit to further improve the accuracy in prediction of process conditions in the method disclosed in Patent Documents 1 and 2 in which a regression model is learned based only on numerical data of the material's process conditions and material properties. Thus, to achieve higher accuracy in prediction, it may be considered to take into account information other than numerical value data, such as microstructure information of a material.

The present invention was made in view of such problems. It is an object of the present invention to provide a prediction apparatus and so on, in which process conditions can be predicted with microstructure information of a material being taken into account.

### Means for Solving Problems

To solve the above problems, a first aspect of the present invention is a prediction apparatus including a generative model building part, a process condition prediction model building part, and an image generation/prediction part. The generative model building part uses microstructure images, which are acquired from a material, as learning data to build a generative model for generating a microstructure image of the material. The process condition prediction model building part builds a process condition prediction model by learning data of process conditions paired with the microstructure images of the material. The process condition prediction model is a regression model and is for predicting process conditions for any microstructure images. The image generation/prediction part generates a microstructure image of a material by inputting sampled latent variables into the generative model built by the generative model building part, and enters the generated microstructure image of the material into the process condition prediction model so as to generate the microstructure image of a material and, at the same time, predict process conditions for the microstructure image.

According to the first aspect of the present invention, by learning the generative model and the regression model using experimental data such as microstructure images and process conditions, process conditions can be predicted with the material microstructure information being taken into account.

In the first aspect of the present invention, it is preferable that epochs for the generative model building part and the process condition prediction model building part are decided based on an accuracy of reconstruction of microstructure images generated by the generative model and distribution of process conditions predicted by the process condition prediction model. Also, it is preferable that adjusting means for adjusting the epochs for the generative model building part and the process condition prediction model building part is further provided. In this way, learning models (the generative model and the process condition prediction model) that can achieve both the accuracy of reconstruction of microstructure images and an accuracy of prediction of process conditions can be built.

Also, it is preferable that the image generation/prediction part enters an image obtained by applying super-resolution process on the microstructure image of the material generated by the generative model into the process condition prediction model to predict process conditions.

Also, it is preferable that the process condition prediction model building part uses, as the microstructure image of the material to be learned, an image obtained by applying super-resolution process on the image rebuilt from the microstructure image of the material by the generative model.

Using the super-resolution processed images for learning and prediction of the process condition prediction model can improve learning and prediction performance.

It is preferable that the first aspect of the present invention further includes a property prediction model building part that builds a property prediction model, which is a regression model that predicts material properties of any microstructure images by learning data of material properties paired with microstructure images of the material, and the image generation/prediction part predicts material properties of the microstructure image of the material generated by using the property prediction model. This makes it possible to further predict the material properties of the generated microstructure image of the material.

Also, it is preferable that the first aspect of the present invention further includes an aimed image acquisition part, which acquires, from microstructure images of the material generated by the image generation/prediction part, a microstructure image of the material having aimed material properties. For example, the aimed image acquisition part may decide whether the material properties, which are predicted by the image generation/prediction part, of the microstructure image generated by the generative model satisfy predetermined aimed conditions or not. If the material properties satisfy the predetermined aimed conditions, the generated microstructure image may be taken as the microstructure image of the material having the aimed material properties. In this way, a microstructure image of a material having aimed material properties can be obtained.

Also, it is preferable that the first aspect of the present invention further includes a visualization part that visualizes prediction results of the process conditions and material properties of the microstructure image of the material having the aimed material properties. This can facilitate evaluation of process conditions and material properties of a microstructure image of a material having aimed material properties.

It is also preferable that epochs for the generative model building part and the property prediction model building part are decided based on an accuracy of reconstruction of microstructure images generated by the generative model and distribution of material properties predicted by the property prediction model. Also, it is preferable that adjusting means for adjusting the epochs for the generative model building part and the property prediction model building part is provided. In this way, learning models (the generative model and the property prediction model) that can achieve both the accuracy of reconstruction of microstructure images and an accuracy of prediction of material properties can be built.

Also, it is preferable that the image generation/prediction part enters an image obtained by applying super-resolution process on the microstructure image of the material generated by the generative model into the property prediction model to predict material properties.

Also, it is preferable that the property prediction model building part uses, as the microstructure image of the material to be learned, an image obtained by applying super-resolution process on the image rebuilt from the microstructure image of the material by the generative model.

Using the super-resolution processed images for learning and prediction of the property prediction model can improve learning and prediction performance.

Also, it is preferable that the image generation/prediction part generates more microstructure images that includes microstructures strongly related to the aimed material properties, or less microstructure images that includes microstructures weakly related to the aimed material properties, compared to a case in which microstructure images are randomly generated. This can make it possible to efficiently generate microstructure images that have characteristics close to the aimed material properties.

Also, it is preferable that distribution of the material properties of the microstructure images generated by the image generation/prediction part has deviation. This makes it possible to generate microstructure images having particular material properties more frequently, thereby preferentially generating microstructure images that meet particular property requirements.

A second aspect of the present invention is a prediction method executed on a computer. The method includes steps of building a generative model for generating a microstructure image of a material using microstructure images, which are acquired from the material, as learning data, building a process condition prediction model, which is a regression model and is for predicting process conditions for any microstructure images by learning data of process conditions paired with the microstructure images of the material, and generating a microstructure image of the material by inputting sampled latent variables into the generative model built in the step of building the generative model and inputting the generated microstructure image of the material into the process condition prediction model built in the step of building the process condition prediction model so as to generate the microstructure image of the material and, at the same time, to predict process conditions for the microstructure image.

A third aspect of the present invention is a storage medium for storing a program that causes a computer to function as a generative model building part that uses microstructure images, which are acquired from a material, as learning data to build a generative model for generating a microstructure image of the material, a process condition prediction model building part that builds a process condition prediction model, which is a regression model for predicting process conditions for any microstructure images, by learning data of process conditions paired with the microstructure images of the material, and an image generation/prediction part that generates a microstructure image of a material by inputting sampled latent variables into the generative model that is built by the generative model building part and enters the generated microstructure image of the material into the process condition prediction model that is built by the process condition prediction model building part so as to generate the microstructure image of the material and, at the same time, predicts process conditions for the microstructure image.

### Effects of the Invention

According to the present invention, process conditions can be predicted with microstructure information of a material being taken into account.

### BRIEF DESCRIPTION OF DRAWINGS

FIG. 1 is a view showing a hardware configuration of a computer that is to be used as a prediction apparatus 1.

FIG. 2 is a block diagram showing a functional configuration of the prediction apparatus 1.

FIG. 3 is a view showing an example in which VQVAE is used as a generative model 31.

FIG. 4 is a view showing examples of microstructure images generated by the generative model 31 of a rare-earth magnet.

FIG. 5 is a view showing examples of microstructure images generated by the generative model 31 of graphite cast iron.

FIG. 6 is a view illustrating a process condition prediction model building part 23.

FIG. 7 is a view showing an example of a manufacturing process of a rare-earth magnet.

FIG. 8 is a view showing an example of diffusion source coating.

FIG. 9 is a view showing an example of heat treatment conditions in a diffusion treatment.

FIG. 10 is a view illustrating generation of a microstructure image and prediction of process conditions in an image generation/prediction part 26.

FIG. 11 is a flowchart showing a flow of processes executed by the prediction apparatus 1.

FIGS. 12A, 12B, and 12C are views showing differences in generated images depending on an epoch.

FIG. 13 is a graph showing a relation between the epoch and a reconstruction loss.

FIG. 14A is a graph of predicted values versus actual measurement values of Fe as a diffusion source composition.

FIG. 14B is a graph of predicted values versus actual measurement values of Ga as a diffusion source composition.

FIG. 14C is a graph of predicted values versus actual measurement values of Cu as a diffusion source composition.

FIG. 15A shows graphs of predicted values versus actual measurement values of the first stage heat treatment conditions (heating temperature and holding time).

FIG. 15B shows graphs of predicted values versus actual measurement values of the second stage heat treatment conditions (heating temperature and holding time).

FIG. 16 is a graph showing a relation between definition of generated images and a generative speed.

FIG. 17 is a view showing an example in which a generated image is applied with a super-resolution process.

FIG. 18 is a block diagram showing a functional configuration of a prediction apparatus 1a.

FIG. 19 is a view illustrating a property prediction model building part 22.

FIG. 20 is a view illustrating generation of microstructure images and prediction of material properties and process conditions in the image generation/prediction part 26.

FIG. 21 is a view showing distribution of predicted values of material properties of generated images that are generated randomly.

FIG. 22 is a flowchart showing a flow of processes executed by the prediction apparatus 1a.

FIG. 23A is a graph of predicted values predicted by a property prediction model 32 versus actual measurement values of magnetic flux density Br [T] of learning data. FIG. 23B is a graph of predicted values predicted by the property prediction model 32 versus actual measurement values of magnetic flux density Br [T] of validation data.

FIG. 23C is a graph of predicted values predicted by the property prediction model 32 versus actual measurement values of magnetic flux density Br [T] of test data.

FIG. 24 is a view showing examples of generated images 5a, 5b, and 5c for a case in which high Br (magnetic flux density) and low HcJ (coercive force) are aimed properties.

FIG. 25 is a view showing examples of generated images 5d, 5e, and 5f for a case in which low Br (magnetic flux density) and high HcJ (coercive force) are aimed properties.

FIG. 26 is a view showing examples of generated images 5g, 5h, and 5i for a case in which high Br (magnetic flux density) and high HcJ (coercive force) are aimed properties.

FIG. 27A is a view showing an example of visualized prediction results of material properties of the generated microstructure image 5g.

FIG. 27B is a view showing an example of visualized prediction results of material properties of the generated microstructure image 5h.

FIG. 27C is a view showing an example of visualized prediction results of material properties of the generated microstructure image 5i.

FIG. 28 is a block diagram showing a functional configuration of a prediction apparatus 1b.

FIG. 29 is a view illustrating an example in which microstructure images 41 for learning are input into an encoder 211 to acquire latent variables Z.

FIG. 30 is a view illustrating an example of learning conditional probability distribution (a self-regression model 34) based on data arrays of the latent variables Z.

FIG. 31 is a view illustrating an example of modifying a Softmax function 342 of the self-regression model to be a Softmax function 342a added with a coefficient T.

FIG. 32 is a graph showing changes in the function when the coefficient of the Softmax function 342a is varied.

FIG. 33 is a flowchart showing a flow of processes executed by the prediction apparatus 1b.

FIG. 34 is a graph showing distribution of material properties of generated images when the coefficient T is adjusted.

### DETAILED DESCRIPTION

Hereinafter, embodiments of the present invention will be described with reference to the accompanying drawings. In the present embodiments, examples in which a prediction apparatus 1 is used to generate microstructure images of rare-earth magnets and to predict process conditions etc. thereof will be described. Materials are not limited to rare-earth magnets and other various materials including metal, magnets, ceramics, and resin, for example, are also applicable.

### First Embodiment

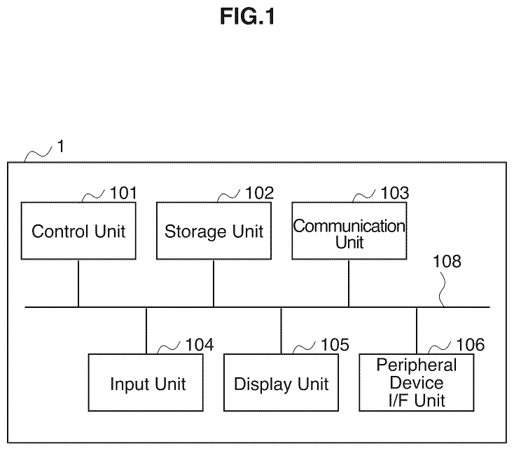

FIG. 1 is a view showing an example of a hardware configuration of the prediction apparatus 1 according to the embodiment of the present invention. When a common personal computer is used as the prediction apparatus 1, for example, the prediction apparatus 1 includes, as shown in FIG. 1, a control unit 101, a storage unit 102, a communication unit 103, an input unit 104, a display unit 105, a peripheral device I/F unit 106, and so on that are connected to each other via a bus 108. The configuration shown in FIG. 1 is one example, and the prediction apparatus 1 may have different configurations according to use and purpose thereof.

The control unit 101 includes a central processing unit (CPU), a read only memory (ROM), a random access memory (RAM), and so on. The CPU reads out programs stored in a storage medium (media) such as the storage unit 102 or the ROM to a working memory area on the RAM, executes the program, and drives and controls the parts that are connected via the bus 108 to realize processes of the prediction apparatus 1, which will be described below.

The ROM is a non-volatile memory and permanently holds programs such as a boot program and BIOS, and data etc. for the computer. The RAM is a volatile memory and temporary holds programs and data loaded from the storage media such as the storage unit 102 and the ROM, and, at the same time, provides a working area for the control unit 101 to perform various processes.

The storage unit 102 is a hard disk drive (HDD), a solid state drive (SSD), a flash memory, or the like, and stores programs executed by the control unit 101, data necessary for execution of the programs, an operation system (OS), and so on. Particularly in the present embodiment, the storage unit 102 stores an application program that causes the prediction apparatus 1 to execute the processes described below.

The communication unit 103 includes a communication interface and a communication control circuit that mediate communications of the prediction apparatus 1. The communication unit 103 controls communications via networks including, regardless of wired or wireless, a local area network (LAN), a wide area network (WAN), and the Internet and the like.

The input unit 104 includes an input device such as a keyboard, a mouse, a touch panel, and various operation buttons. The input unit 104 sends input data and operation instructions to the control unit 101.

The display unit 105 includes a display etc., such as a liquid crystal panel, and displays data, such as images or texts, on the display following the instructions of the control unit 101.

The peripheral device I/F unit 106 is a port for connecting a peripheral device, including a USB or short-distance wireless communications such as Bluetooth (registered trademark). The control unit 101performs data transmission and reception with the peripheral device via the peripheral device I/F unit 106. A printer or the like, for example, is connected to the peripheral device I/F unit 106.

Next, a functional configuration of the prediction apparatus 1 will be described.

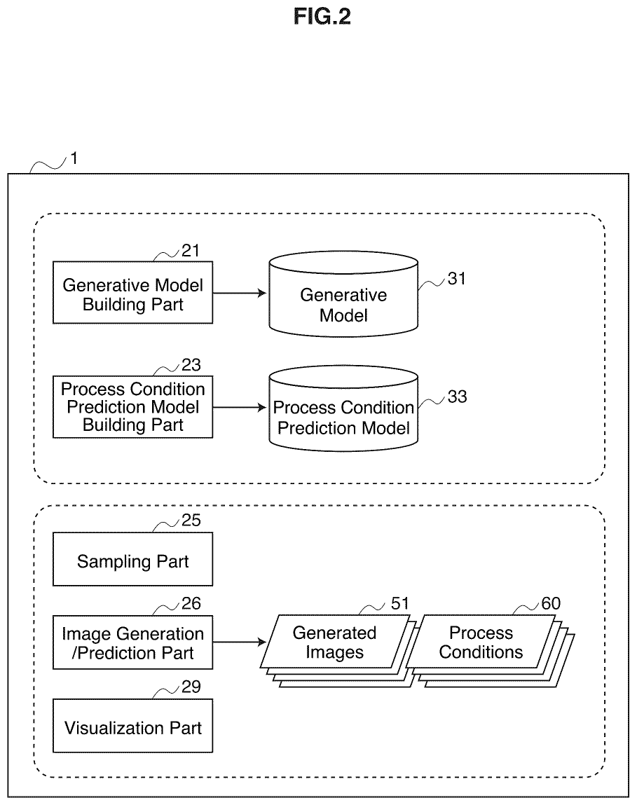

FIG. 2 is a block diagram showing the functional configuration of the prediction apparatus 1 according to the present embodiment. As shown in the drawing, the prediction apparatus 1 includes a generative model building part 21, a process condition prediction model building part 23, a sampling part 25, an image generation/prediction part 26, and a visualization part 29. The control unit 101 of the prediction apparatus 1 reads out and executes the programs stored in the storage unit 102 or the ROM to realize such functions.

The generative model building part 21 uses microstructure images 41 (hereafter, may be referred to as microstructure images 41 for learning), which are acquired from a material, as learning data to build a generative model 31 for generating a microstructure image of a material. The microstructure images 41 for learning used as learning data are images that are acquired from a target material under an electron microscope or the like. The microstructure images 41 for learning are linked to process conditions (actual measurement values) and stored in the storage unit 102 or in a storage or the like that is communicably connected via the communication unit 103.

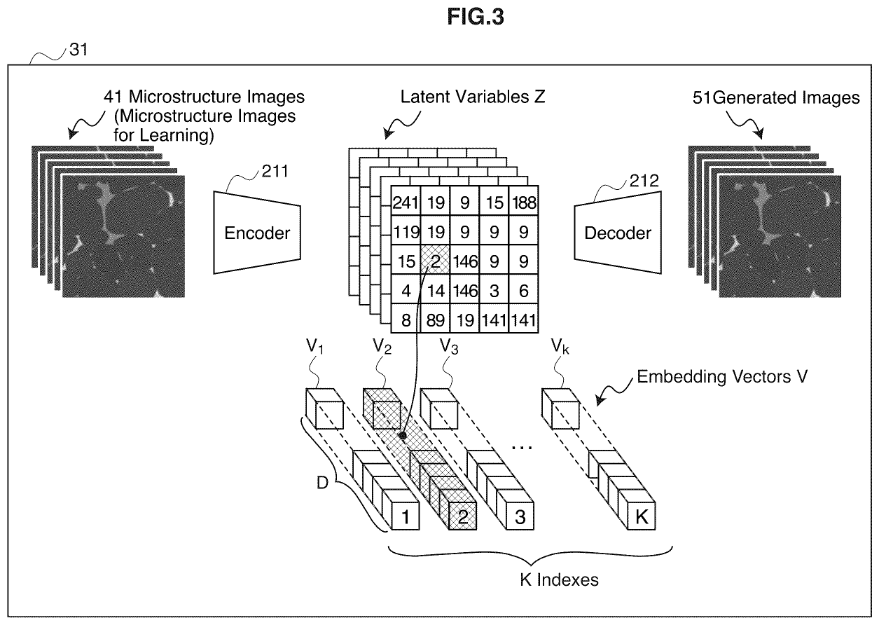

FIG. 3 is a schematic view illustrating building of the generative model 31 by the generative model building part 21. FIG. 3 shows an example of a vector quantized variational auto-encoder (VQVAE). An encoder 211 is a functional part for compressing an image to low-dimensional latent variables Z, and a decoder 212 is a functional part for restoring the original image from the latent variables Z. The encoder 211 and the decoder 212 are built by a neural network such as a convolutional neural network (CNN). As shown in the drawing, by causing the encoder 211, the decoder 212, and VQVAE including embedding vectors V to learn the microstructure images 41 for learning acquired from materials as learning data, the generative model 31 that generates images (generated images) 51 similar to the microstructure images 41 for learning is built.

The generative model 31 is not limited to VQVAE, and VAE, VQVAE2, generative adversarial networks (GAN), Gaussian Copula, and other unsupervised machine learning may also be used.

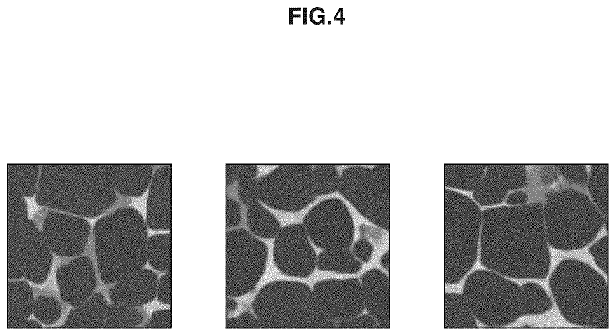

FIG. 4 is a view showing examples of microstructure images (generated images) of a rare-earth magnet generated by the generative model 31. The images are generated by the generative model 31 that has learned the microstructure images acquired from the rare-earth magnet as learning data.

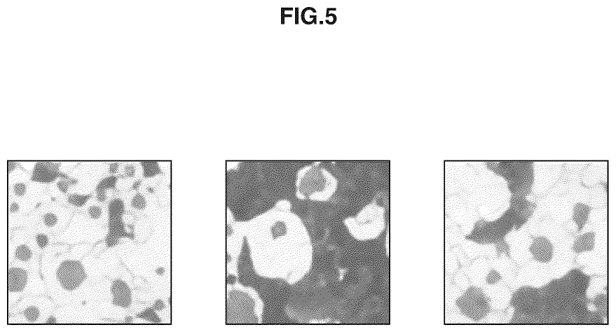

FIG. 5 is a view showing examples of microstructure images (generated images) of a graphite cast iron generated by the generative model 31. The images are generated by the generative model 31 that has learned the microstructure images acquired from the graphite cast iron as learning data.

Next, the process condition prediction model building part 23 in FIG. 2 will be described. The process condition prediction model building part 23 uses learning data 43 of process conditions paired with microstructure images of the material, to learn and build a regression model (a process condition prediction model 33) for predicting process conditions of any microstructure images (generated images).

The microstructure images of the material for the learning data 43 here are the images (hereafter, referred to as generated images 51 for learning) that are restored (rebuilt) by the generative model 31 from the microstructure images 41 (see FIG. 3) that have been used to build the generative model 31. That is, the microstructure images of the material for the learning data 43 are obtained by inputting the microstructure images 41 for learning into the learned encoder 211 to obtain the latent variables Z and then inputting the latent variables Z into the learned decoder 212.

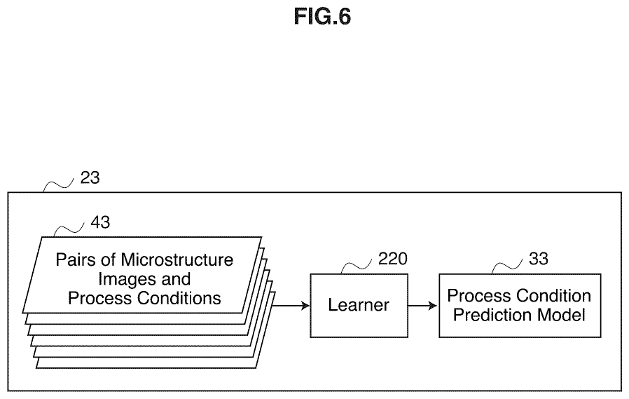

FIG. 6 is a schematic view illustrating building of the process condition prediction model 33 by the process condition prediction model building part 23. As shown in the drawing, the process condition prediction model building part 23 builds the process condition prediction model 33 by inputting the learning data 43 of process conditions paired with the microstructure images of the material (the generated images 51 for learning) into a learner 220 for supervised learning.

The learner 220 takes the generated images 51 for learning of the learning data 43 as explanatory variables (input) and process conditions 60 that are paired with the generated images 51 for learning as objective variables (output), and learns the process condition prediction model 33 by CNN or other well-known machine learning. When a microstructure image (a generated image) with unknown process conditions is input, the learned process condition prediction model 33 predicts and outputs the process conditions 60 for the microstructure image (the generated image).

Although the process condition prediction model 33 is learned with the generated images 51 for learning as the explanatory variables, the process condition prediction model 33 may be learned with the microstructure images 41 for learning, in place of the generated images 51 for learning, as the explanatory variables. Also, the process condition prediction model 33 may be learned with the latent variables Z used at the time of generating the generated images 51 for learning as the explanatory variables.

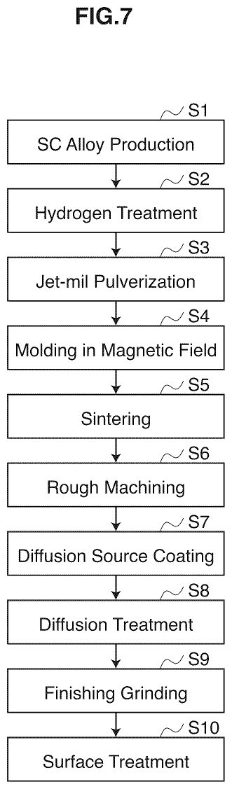

One example of manufacturing processes of the rare-earth magnet will be described here. FIG. 7 is a flowchart showing a manufacturing process of the rare-earth magnet. As shown in the drawing, following a production of an SC alloy (a step S1), hydrogen treatment (a step S2), jet-mill pulverization (a step S3), and molding in a magnetic field (a step S4), sintering (a step S5), and rough machining (a step S6) are carried out. Then, through processes of diffusion source coating (a step S7) and diffusion treatment (a step S8), finishing grinding (a step S9) and surface treatment (a step S10) are carried out so that the rare-earth magnet is manufactured. In the present embodiment, within the above manufacturing process, process conditions for the diffusion source coating (the step S7) and the diffusion treatment (the step S8) are the subject of prediction.

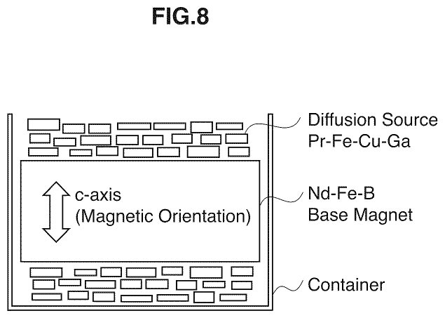

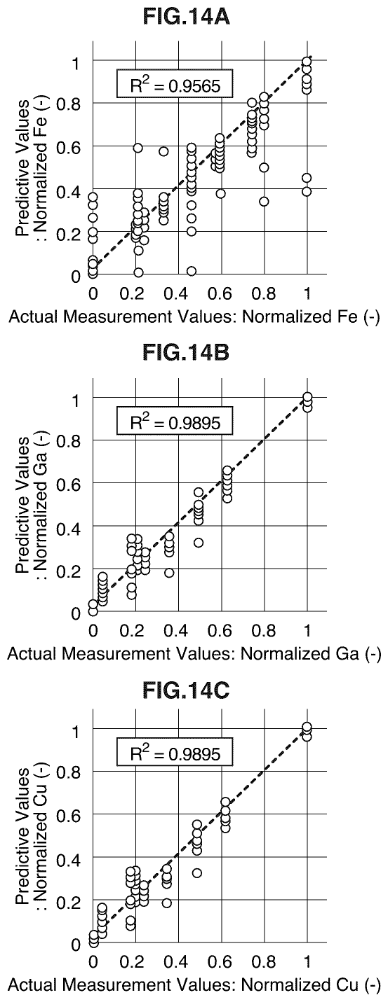

FIG. 8 is a view showing an example of diffusion source coating in the step S7. The drawing illustrates an example in which a diffusion source Pr—Fe—Cu—Ga is coated onto a base magnet Nd—Fe—B inside a container (however, the base magnet and the diffusion source are not limited to the illustrated example). In the present embodiment, a composition of the diffusion source is to be taken as the process conditions to be predicted in the diffusion source coating (FIG. 14).

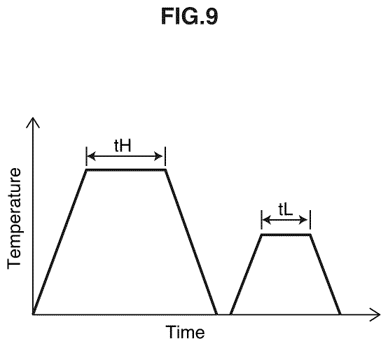

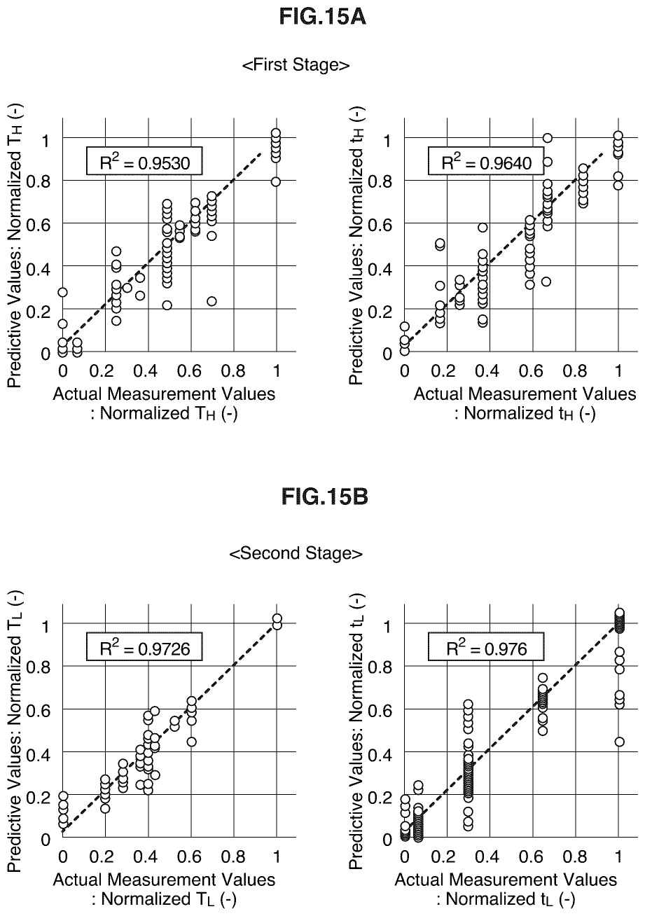

FIG. 9 is a view showing an example of heat treatment conditions in the diffusion treatment in the step S8. In the present embodiment, heat treatment is performed in two stages with the diffusion source being coated onto the base magnet. The diffusion source is diffused into the base magnet during the heat treatment, thereby changing the material characteristics. In the present embodiment, the first stage heat treatment conditions (heating temperature TH, holding time tH) and the second stage heat treatment conditions (heating temperature TL, holding time tL) are to be taken as process conditions to be predicted in the diffusion treatment (FIG. 15).

The process conditions to be predicted are not limited to the above examples, and various process conditions may be the subject of prediction. Also, the manufacturing process illustrated in FIG. 7 is just an example and other manufacturing processes may be adopted.

The sampling part 25 samples the latent variables Z that are to be input into the decoder 212 of the generative model 31 to generate microstructure images.

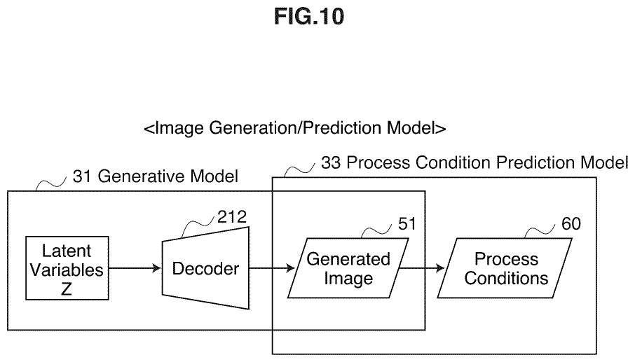

The image generation/prediction part 26 couples the generative model 31 built by the generative model building part 21 with the process condition prediction model 33 built by the process condition prediction model building part 23 to build the image generation/prediction model, and generates, by using the image generation/prediction model, any microstructure images, and, at the same time, predicts process conditions for the generated microstructure images. More specifically, the image generation/prediction part 26 enters the latent variables Z sampled by the sampling part 25 into the decoder 212 of the generative model 31 as shown in FIG. 10 to generate the generated image 51. The image generation/prediction part 26 also predicts the process conditions 60 for the generated image 51 that has been generated by using the process condition prediction model 33.

The visualization part 29 displays the generated image 51 that has been generated by the image generation/prediction part 26 and the process conditions 60 thereof on the display unit 105 (a screen). The visualization part 29 may also display a process condition map, in which the predicted process conditions 60 are plotted in a graph or on microstructure images 5, or a SHAP distribution map, in which SHAP values are plotted in graphs or on the microstructure images 5.

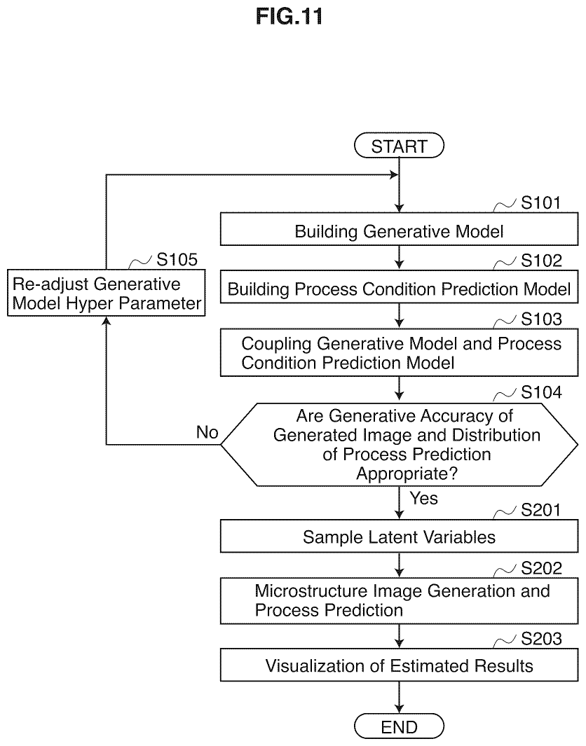

Next, a flow of processes carried out by the prediction apparatus 1 (a method of prediction) will be described with a reference to a flowchart shown in FIG. 11. The control unit 101 of the prediction apparatus 1 executes the process of each step in FIG. 11 to realize each function of the prediction apparatus 1.

The control unit 101 of the prediction apparatus 1 acquires the microstructure images 41 (microstructure images 41 for learning), which acquired from a material, as learning data from the storage unit 102 or the like, and learns and builds the generative model 31 such as VQVAE (a step S101).

The control unit 101 also builds, by using the learning data 43, which is a pair of the microstructure image and the process conditions, the process condition prediction model 33, which is a regression model for prediction of process conditions of any microstructure images (generated image) (a step S102). More specifically, the control unit 101 takes the generated images 51 for learning, which are images of the microstructure images 41 for learning restored (reconstruction) by the generative model 31, as explanatory variables (input) and process conditions 60 that are paired with the generated images 51 for learning as objective variables (output) to learn the process condition prediction model 33 so as to build the process condition prediction model 33 that predicts the process conditions 60 from any microstructure images (the generated image).

In the steps S101 and S102, microstructure images 41 for learning and the generated images 51 for learning that are used as learning data may be divided into rectangular images having a predetermined size to be used.

Next, the control unit 101 couples the generative model 31 built in the step S101 with the process condition prediction model 33 built in the step S102 to produce the image generation/prediction model (a step S103). The image generation/prediction model outputs any generated images 51 by the generative model 31 as well as outputs predicted values of the process conditions 60 of the generated images 51 by the process condition prediction model 33.

Here, an operator performs, using validation data and test data, a validation/test on the image generation/prediction model produced in the step S103 to determine whether an accuracy of reconstruction of the generated images 51 generated and distribution of the predicted values of the process conditions 60 are suitable or not (a step S104). If unsuitable (a step S104: NO), the operator adjusts a hyper parameter of the generative model 31 (a step S105) and retries the building of the generative model 31 (the step S101) and the building of the process condition prediction model 33. The hyper parameter is an epoch, for example.

In the step S104, for the operator to visually check the accuracy of reconstruction and the distribution of predicted values of the process conditions 60, it is preferable that the control unit 101 displays on the display unit 105 an original image on a side of the generated image 51 restored by the generative model 31 from the original image, and the distribution of the process conditions 60 predicted by the process prediction model 33. The control unit 101 may also display an “ADJUSTMENT” button for transition to a hyper parameter adjusting screen as well as a “NEXT” button for transition to the next process such that the control unit 101 receives an input of suitable/unsuitable.

If the operator decides that the accuracy of reconstruction of the generated image 51 and the distribution of predicted values of the process conditions 60 are unsuitable (the step S104: NO), the operator operates the “ADJUSTMENT” button for transition to the hyper parameter adjusting screen, for example. In such the case, the control unit 101 displays the hyper parameter adjusting screen to receive from the operator an adjustment on the epoch or the like (the step S105). A function in the step S105 in which the control unit 101 executes “displaying the hyper parameter adjusting screen to receive from the operator an adjustment on the epoch or the like” is one example of “adjusting means” according to the present invention. The adjustment of the hyper parameter may be done not only on the adjusting screen but also by directly correcting a corresponding part of the program.

The operator repeats learning, verifying, and testing on the generative model 31 and the process condition prediction model 33 while adjusting the hyper parameter (the steps S101-S105). Then, when the operator decides that the accuracy of reconstruction of the generated images 51 generated and the distribution of predicted values of the process conditions 60 are suitable (the step S104: YES), the learning processes are terminated, transitioning to a next step S201.

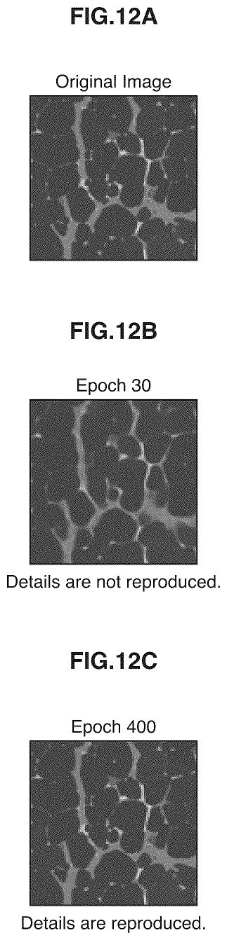

FIG. 12A-FIG. 12C are views showing differences in generated images depending on the epoch. FIG. 12A is an original image, FIG. 12B is a generated image (a restored image of the original image) with epoch 30, and FIG. 12C is a generated image (a restored image of the original image) with epoch 400. As shown in the drawings, in the case of epoch 400, more details are reproduced and thus the accuracy of reconstruction is higher than in the case of epoch 30.

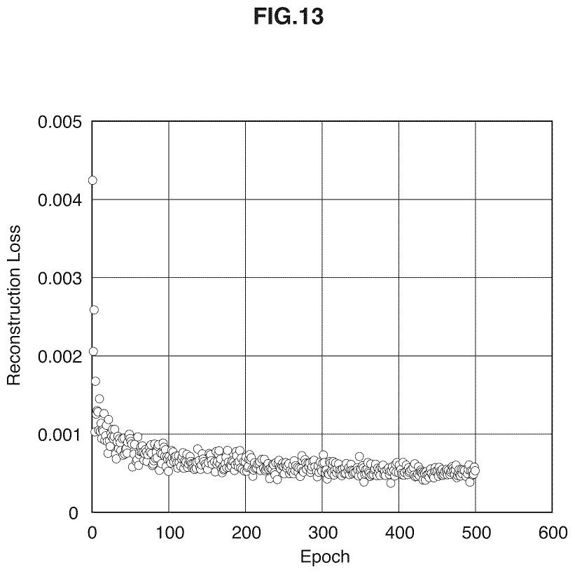

FIG. 13 is a graph showing a relation between the epoch and a reconstruction loss. The reconstruction loss is a value representing a difference between the original image and the restored image (generated image) of the original image. The smaller reconstruction loss means that the accuracy of the reconstruction of the image is higher.

As shown in FIG. 12 and FIG. 13, the accuracy of reconstruction of the image increases as the epoch increases. However, if the accuracy of reconstruction is too high, the distribution of the process conditions may not suitably spread and an accuracy of prediction of process conditions for unknown generated images may be deteriorated. For this reason, to decide the most suitable epoch that can achieve both the accuracy of the reconstruction and the accuracy of prediction of process conditions, the present embodiment provides in the steps S104-S105 in FIG. 11 the process in which the epoch is adjusted while checking whether both the accuracy of reconstruction and the distribution of prediction values of process conditions are suitable or not.

Note that, in the step S104, the control unit 101 may evaluate the accuracy of reconstruction and the distribution of predicted values of process conditions by using predetermined criteria and automatically decide the suitability. For example, the control unit 101 may decide that the accuracy of reconstruction is suitable if the reconstruction loss is less than a predetermined threshold, or unsuitable if the reconstruction loss is more or equal to the predetermined threshold. Also, the control unit 101 may decide that the distribution of predicted values of process conditions is suitable if a statics indicator of variance values or the like of the distribution satisfies predetermined conditions, or unsuitable if the statics indicator does not satisfy the predetermined conditions. Then, when it is decided that both the accuracy of reconstruction and the distribution of the predicted values of the process conditions are suitable (the step S104: YES), the learning processes are terminated, transitioning to a next step S201.

FIG. 14 and FIG. 15 are graphs showing prediction performance of the learned process condition prediction model 33 (a regression model). In both FIG. 14 and FIG. 15, a normalization process is carried out based on actual measurement values. FIG. 14A-14C are graphs of predicted values versus actual measurement values of diffusion source compositions, and FIG. 14A is a graph of Fe composition, FIG. 14B is a graph of Ga composition, and FIG. 14C is a graph of Cu composition. Each graph has a coefficient of determination R2 shown, which is a performance indicator of a regression model; and the coefficients of determination R2 for the compositions Fe, Ga, and Gu arc: R2=0.9565, R2=0.9895, and R2=0.9895, respectively. FIG. 15A and FIG. 15B are graphs of predicted values versus actual measurement values of heat treatment conditions (heating temperature and holding time), in which FIG. 15A is a graph of heat treatment conditions (heating temperature and holding time) in the first stage and FIG. 15B is a graph of heat treatment conditions (heating temperature and holding time) in the second stage. The coefficients of determination R2 for the heating temperature and holding time in the first stage are R2=0.9530 and R2=0.9640, respectively, and the coefficients of determination R2 for the heating temperature and holding time in the second stage are R2=0.9726 and R2=0.976, respectively. It can be seen from FIG. 14 and FIG. 15 that high prediction accuracy is achieved for both the diffusion source compositions and heat treatment conditions, and the process condition prediction model 33 with excellent prediction performance has been created.

Resuming the description of the flowchart in FIG. 11, the control unit 101 samples the latent variables Z that are to be input into the generative model 31 (the decoder 212) of the image generation/prediction model (a step S201). The latent variable Z in the present embodiment is any data such as random noise, for example.

The control unit 101 generates the microstructure image (the generated image 51) by the image generation/prediction model with the latent variables Z (any data such as random noise) sampled in the step 201 as an input, and then predicts the process conditions 60 for the generated image 51 (a step S202). The output data of the control unit 101 includes the generated image 51 and the process conditions 60 predicted from the generated image 51.

Next, the control unit 101 performs a visualization process (a step S203). In the visualization process, the control unit 101 displays the generated image 51 (microstructure image) that has been generated and the prediction results of the process conditions 60 on the display unit 105. Also, as a way of visualization, a method for generating a material properties map as described in JP-A-2021-111360, or the like, may be used. JP-A-2021-111360 describes that a microstructure image is cut out into rectangular regions of a predetermined size and SHAP values of magnetic flux density and coercive force are calculated for each of the cutout regions to generate a SHAP value map. SHAP (SHapley Additive explanations) is a technique of explainable AI (XAI) and is a method for quantitatively calculating how much impact each explanatory variable has on prediction results output by a prediction model. A map for the process conditions may be generated by applying such the method to the case of the process conditions.

As described above, the prediction apparatus 1 of the present embodiment learns the generative model 31 using the microstructure images acquired from the material as learning data, learns the process condition prediction model 33 using the data, which is a pair of the microstructure images of the material and the process conditions, as learning data, and builds the image generation/prediction model by coupling the generative model 31 with the process condition prediction model 33. In this way, any microstructure images can be generated and, at the same time, a learning model for predicting the process conditions of the generated microstructure image is built. Thus, prediction of process conditions taking into account the microstructure information of the material is possible. Also, when a microstructure image having an ideal microstructure is given, by inputting the microstructure image into the process condition prediction model 33, the prediction apparatus 1 can predict process conditions that can realize the ideal microstructure. Also, when a microstructure image having an abnormal microstructure is given, by inputting the microstructure image into the process condition prediction model 33, the prediction apparatus 1 can predict process causes of the abnormal microstructure.

### (Application of Super-Resolution Process)

A super-resolution process may be applied to images generated by the generative model 31. In this way, generated images with higher definition can be obtained without excessively raising calculation cost.

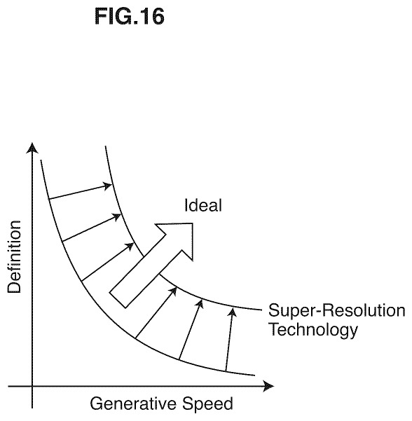

FIG. 16 is a graph showing a relation between definition of generated images and a generative speed. From the drawing, it can be seen that the relation between the definition of generated images and the generative speed is a trade-off. In other words, to generate a high definition image, the generative speed is to be low. Although it is possible to obtain a higher definition generated image by increasing complexity of the generative model 31, the calculation cost will be extremely high when generating images in a large scale. Thus, instead of increasing the complexity of the generative model 31 itself, the generated image generated by the generative model 31 may be treated with the super-resolution process. This can improve the definition while suppressing the increase in the calculation cost, thereby alleviating the trade-off between the definition of the generated image and the generative speed.

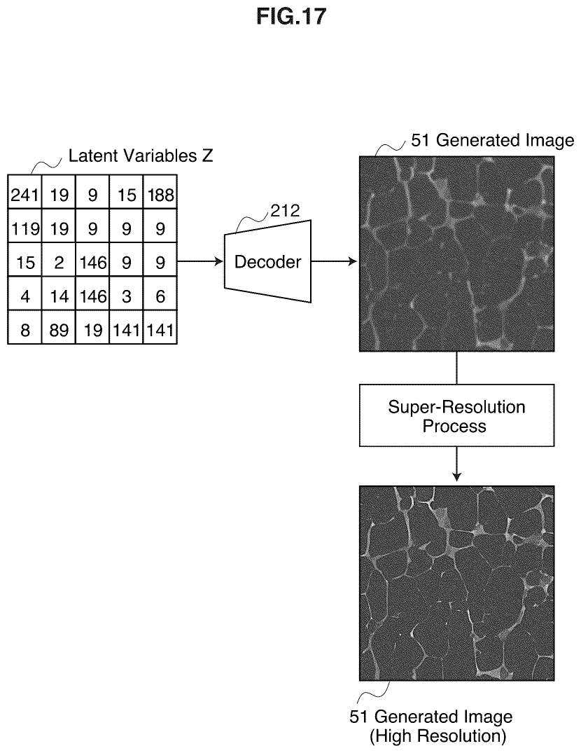

FIG. 17 is a view showing an example in which the super-resolution process is applied to a generated image. As shown in the drawing, the super-resolution process is applied to the generated image 51 that is output from the decoder 212 of the learned generative model 31. In this way, the generated image 51 with high definition can be obtained. For the super-resolution process, a well-known method for sharpening images may be used.

In the processes shown in FIG. 11, the super-resolution process can be applied at the time of generating images (the step S202 in FIG. 11). More specifically, in the step S202 in FIG. 11, the control unit 101 (the image generation/prediction part 26) applies the super-resolution process to the microstructure image (the generated image 51) generated by the generative model 31 of the image generation/prediction model, outputs the sharpened generated image 51, enters the sharpened generated image 51 into a property prediction model 32 of the image generation/prediction model, and predicts material properties 61.

The super-resolution process may also be applied at the time of learning the property prediction model 32 (the step S102 in FIG. 11). More specifically, in the step S102 in FIG. 11, the control unit 101 (a property prediction model building part 22) applies the super-resolution process to the microstructure image 51 for learning, which is the microstructure image 41 for learning that has been restored (reconstruction) by the generative model 31, and learns the property prediction model 32 with the sharpened microstructure image 51 for learning as an explanatory variable (input) and the material properties 61 that are paired with the generated images 51 for learning as objective variables (output).

By applying the super-resolution process as above, the generated image 51 can be sharpened without increasing the complexity of the generative model 31. As a result, images having high definition can be generated at a practical generative speed when generating the generated images in a large scale.

### Second Embodiment

Next, a second embodiment will be described. In the second embodiment, material properties are additionally predicted from a generated image.

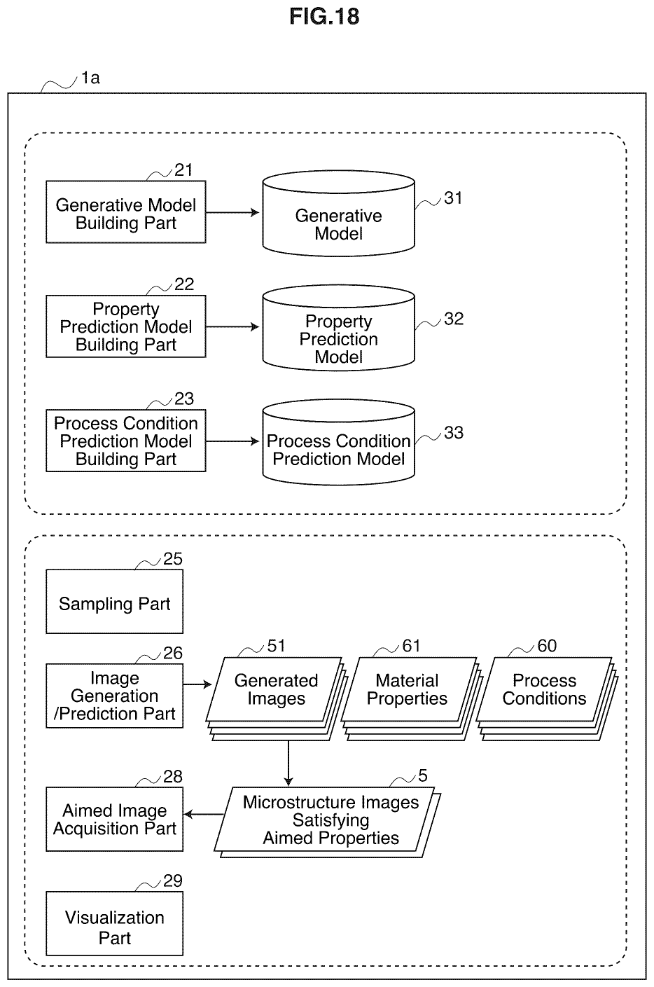

FIG. 18 is a block diagram showing a functional configuration of a prediction apparatus 1a according to the second embodiment. In addition to the functional configuration of the prediction apparatus 1 (FIG. 2), the prediction apparatus 1a further includes the property prediction model building part 22 and an aimed image acquisition part 28.

Similarly to the first embodiment, the generative model building part 21 uses the microstructure images 41 (the microstructure images 41 for learning), which are acquired from a material, as learning data to build the generative model 31 for generating a microstructure image of a material. In the second embodiment, the microstructure images 41 for learning are linked to material properties (actual measurement values) in addition to the process conditions (actual measurement values), and stored in the storage unit 102 or in a storage or the like that is communicably connected via the communication unit 103. The material properties are characteristic values of a material, such as magnetic flux density Br and coercive force HcJ.

The property prediction model building part 22 uses learning data 42, which is a pair of microstructure images and material properties of a material, to learn and build a regression model (the property prediction model 32) that predicts material properties of any microstructure images (generated image).

The microstructure images of the material for the learning data 42 here are the images (the generated images 51 for learning) that are restored (reconstruction) by the generative model 31 from the microstructure images 41 (see FIG. 3) used at the time of building the generative model 31. That is, the microstructure images of the material for the learning data 43 are obtained by inputting the microstructure images 41 for learning into the learned encoder 211 to obtain the latent variables Z and then inputting the latent variables Z into the learned decoder 212.

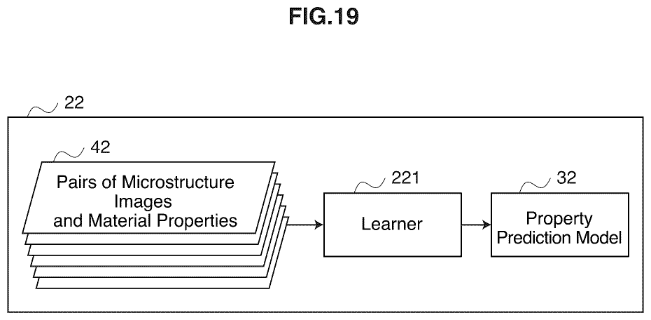

FIG. 19 is a schematic view illustrating a building of the property prediction model 32 by the property prediction model building part 22. As shown in the drawing, the property prediction model building part 22 builds the property prediction model 32 by inputting the learning data 42, which is the microstructure images of the material (the generated images 51 for learning) paired with the material properties thereof, into a learner 221 for supervised learning.

The learner 221 takes the generated images 51 for learning of the learning data 42 as explanatory variables (input) and material properties 61 that are paired with the generated images 51 for learning as objective variables (output), and learns the property prediction model 32 by CNN or other well-known machine learning. When a microstructure image (a generated image) with unknown material properties is input, the learned property prediction model 32 predicts and outputs the material properties 61 for the microstructure image (the generated image).

Although the property prediction model 32 is learned with the generated images 51 for learning as the explanatory variables in the present embodiment, the property prediction model 32 may be learned with the microstructure images 41 for learning (actual data) as the explanatory variables. Also, the property prediction model 32 may be learned with the latent variables Z used at the time of generating the generated images 51 for learning as the explanatory variables.

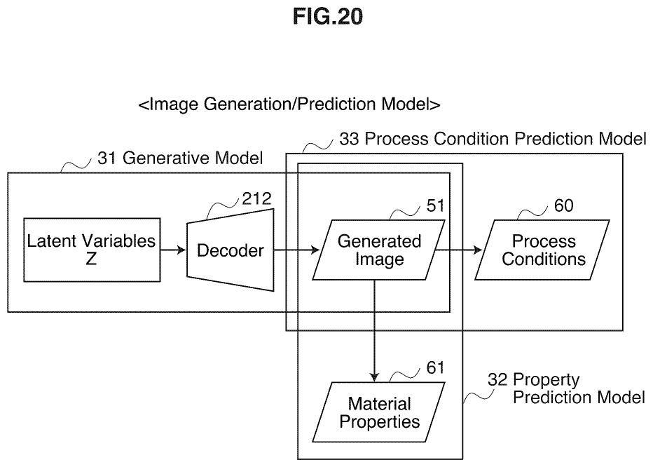

The image generation/prediction part 26 couples the generative model 31 built by the generative model building part 21, the process condition prediction model 33 built by the process condition prediction model 33, and the property prediction model 32 built by the property prediction model building part 22 to build the image generation/prediction model, and generates, by using the image generation/prediction model, any microstructure images, and, at the same time, predicts process conditions and material properties for the generated microstructure images. More specifically, the image generation/prediction part 26 enters the latent variables Z, which have been randomly sampled by the sampling part 25, into the decoder 212 of the generative model 31 as shown in FIG. 20 to randomly generate the generated image 51. Then, the image generation/prediction part 26 predicts, for the generated image 51 that has been generated, the process conditions 60 by using the process condition prediction model 33 and the material properties 61 by using the property prediction model 32.

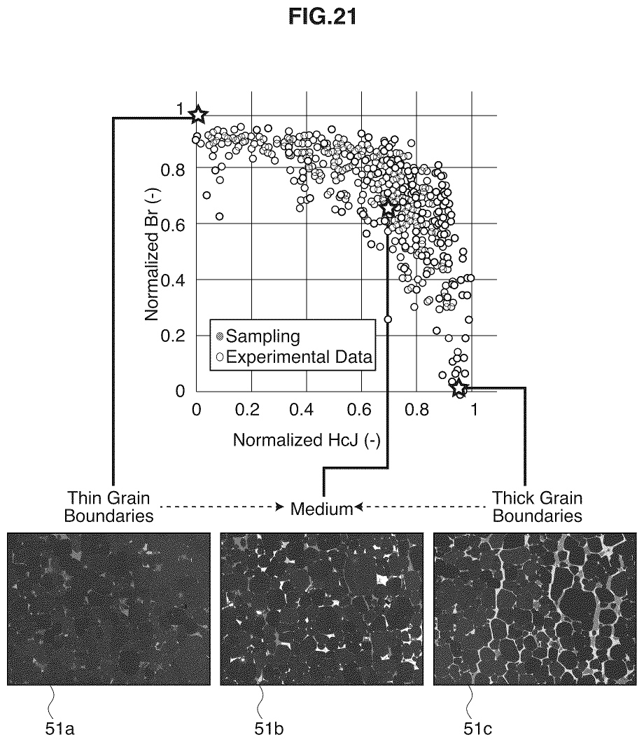

FIG. 21 is a view showing distribution of predicted values of the material properties 61 of the generated images 51 (generated images of rare-earth magnets) that are generated randomly by the generative model 31. On the graph, the vertical axis shows magnetic flux density Br and the horizontal axis shows coercive force HcJ. The actual data is normalized such that the minimum value is 0 and the maximum value is 1 on both the vertical and horizontal axes. White dots on the graph represent distribution of the material properties of experimental data, and black dots represent distribution of the predicted values of the material properties of the sampled generated images 51, which have been sampled from the generated images 51 that are randomly generated in a large scale. As shown in the graph, the distribution of the predicted values of the material properties of the generated images 51 covers almost the whole area of the distribution of the material properties of experimental data, and thus the generative model 31 can generate the generated images 51 having a variety of properties. For example, as shown in the drawing, it is possible to generate a generated image 51a having a high Br-low HcJ properties, a generated image 51c having a low Br-high HcJ properties, a generated image 51b having a medium properties, and the like. Looking at the microstructures, it can be seen that the generated image 51a has a thin grain boundary, the generated image 51c has a thick grain boundary, and the generated image 51b has a medium grain boundary between that of the generated image 51a and that of the generated image 51c.

The aimed image acquisition part 28 acquires, out of the microstructure images (generated images 51) generated by the image generation/prediction part 26, a microstructure image (a generated image 5) of a material having the aimed material properties. More specifically, the aimed image acquisition part 28 decides whether the material properties 61 predicted by the image generation/prediction part 26 satisfy predetermined aimed conditions or not. If the material properties 61 satisfy the predetermined aimed conditions as a result of the decision, the generated image 51 is acquired as the microstructure image 5 of the material having the aimed material properties.

The visualization part 29 displays on the display unit 105 the predicted results of the process conditions and the material properties of the microstructure image 5, which has been acquired by the aimed image acquisition part 28, of the material having the aimed material properties. The visualization part 29 may also display a process condition map or a property map, in which the predicted process conditions 60 or the material properties 61 are plotted in a graph or on microstructure image 5, or a SHAP distribution map, in which SHAP values are plotted in a graph or on the microstructure image 5.

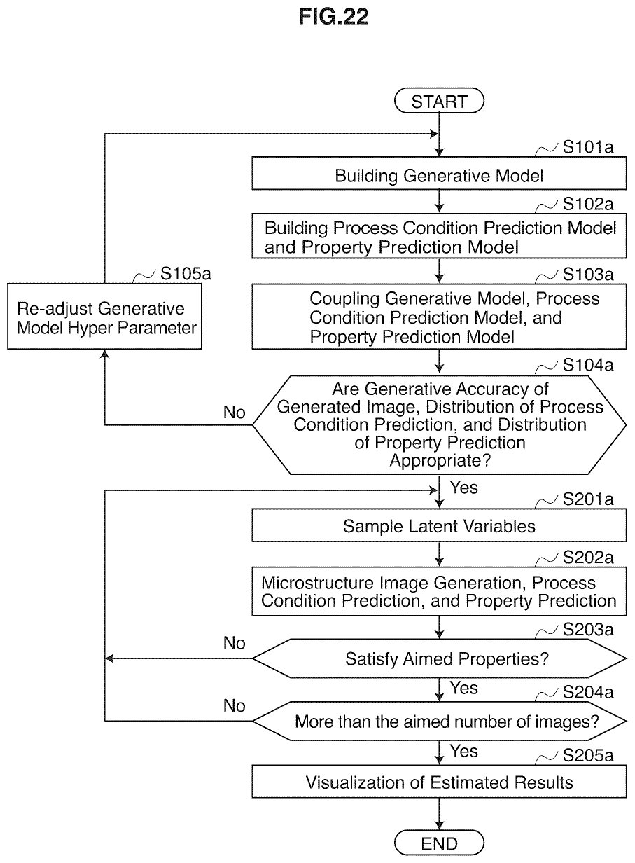

Next, a flow of processes carried out by the prediction apparatus 1a (a method of prediction) will be described with a reference to a flowchart shown in FIG. 22. The control unit 101 of the prediction apparatus 1a executes the process of each step in FIG. 22 to realize each function of the prediction apparatus 1a.

The control unit 101 of the prediction apparatus 1a acquires the microstructure images 41 (microstructure images 41 for learning), which are acquired from a material, as learning data from the storage unit 102 or the like, and learns and builds the generative model 31 such as VQVAE (a step S101a).

Next, in a step S102a, the control unit 101 builds, by using the learning data 43, which is a pair of the microstructure image and the process conditions, the process condition prediction model 33, which is a regression model for prediction of process conditions of any microstructure images (generated images). More specifically, the control unit 101 takes the generated images 51 for learning, which are images of the microstructure images 41 for learning restored (reconstruction) by the generative model 31, as explanatory variables (input) and process conditions 60 that are paired with the generated images 51 for learning as objective variables (output) to learn the process condition prediction model 33 so as to build the process condition prediction model 33 that predicts the process conditions 60 from any microstructure images (the generated images).

Also in the step S102a, the control unit 101 builds, by using the learning data 42, which is a pair of the microstructure image and the material properties, the property prediction model 32, which is a regression model for prediction of material properties of any microstructure images (generated images). More specifically, the control unit 101 takes the generated images 51 for learning, which are images of the microstructure images 41 for learning restored (reconstruction) by the generative model 31, as explanatory variables (input) and material properties 61 that are paired with the generated images 51 for learning as objective variables (output) to learn the property prediction model 32 so as to build the property prediction model 32 that predicts material properties 61 from any microstructure images (the generated images).

In the steps S101a and S102a, the microstructure images 41 for learning and the generated images 51 for learning that are used as learning data may be divided into rectangular images having a predetermined size to be used.

Next, the control unit 101 couples the generative model 31 built in the step S101a with the process condition prediction model 33 and the property prediction model 32 built in the step S102a to produce the image generation/prediction model (a step S103a). The image generation/prediction model outputs any generated images 51 by the generative model 31 as well as outputs predicted values of the process conditions 60 of the generated images 51 by the process condition prediction model 33 and predicted values of the material properties 61 of the generated images 51 by the property prediction model 32.

Here, an operator performs, using validation data and test data, a validation/test on the image generation/prediction model produced in the step S103a to determine whether an accuracy of reconstruction of the generated images 51 generated and distribution of the predicted values of the process conditions 60 and the material properties 61 are suitable or not (a step S104a). If unsuitable (the step S104a: NO), the operator adjusts a hyper parameter of the generative model 31 (a step S105a) and retries building the generative model 31 (the step S101a) and building the process condition prediction model 33 and the property prediction model 32 (the step S102a). The hyper parameter is an epoch, for example.

In the step S104a, for the operator to visually check the accuracy of reconstruction and the distribution of predicted values of the process conditions 60 and the material properties 61, it is preferable that the control unit 101 displays on the display unit 105 an original image on a side of the generated image 51 restored by the generative model 31 from the original image, the distribution of the process conditions 60 predicted by the process prediction model 33, and the distribution of the material properties 61 predicted by the property prediction model 32. The control unit 101 may also display an “ADJUSTMENT” button for transition to a hyper parameter adjusting screen as well as a “NEXT” button for transition to the next process such that the control unit 101 receives an input of suitable/unsuitable.

If the operator decides that the accuracy of reconstruction of the generated image 51 and the distribution of predicted values of the process conditions 60 and the material properties 61 are unsuitable (the step S104a: NO), the operator operates the “ADJUSTMENT” button for transition to the hyper parameter adjusting screen, for example. In such the case, the control unit 101 displays the hyper parameter adjusting screen to receive from the operator an adjustment on the epoch or the like (the step S105a). A function in the step S105a in which the control unit 101 executes “displaying the hyper parameter adjusting screen to receive from the operator an adjustment on the epoch or the like” is one example of “adjusting means” according to the present invention. The adjustment of the hyper parameter may be done not only on the adjusting screen but also by directly correcting a corresponding part of the program.

The operator repeats learning, verifying, and testing on the generative model 31, the process condition prediction model 33, and the property prediction model 32 while adjusting the hyper parameter (the steps S101a-S105a). Then, when the operator decides that the accuracy of reconstruction of the generated images 51 generated and the distribution of predicted values of the process conditions 60 and the material properties 61 are suitable (the step S104a: YES), the learning processes are terminated, transitioning to a next step S201a.

Note that, in the step S104a, the control unit 101 may evaluate the accuracy of reconstruction and the distribution of predicted values of process condition and material properties using predetermined criteria and automatically decide the suitability. For example, the control unit 101 may decide that the accuracy of reconstruction is suitable if the reconstruction loss is less than a predetermined threshold, or unsuitable if the reconstruction loss is more or equal to the predetermined threshold. Also, the control unit 101 may decide that the distribution of predicted values of process conditions or the material properties is suitable if a statics indicator of variance values or the like of the distribution satisfies predetermined conditions, or unsuitable if the statics indicator does not satisfy the predetermined conditions. Then, when it is decided that both the accuracy of reconstruction and the distributions of the predicted values of the process conditions and the material properties are suitable (the step S104a: YES), the learning processes are terminated, transitioning to a next step S201a.

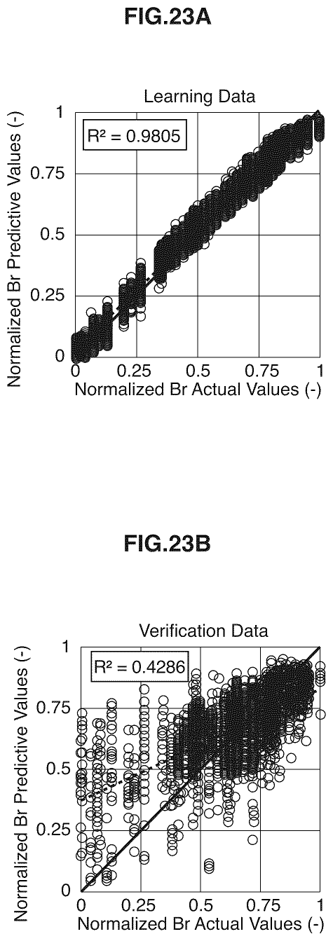

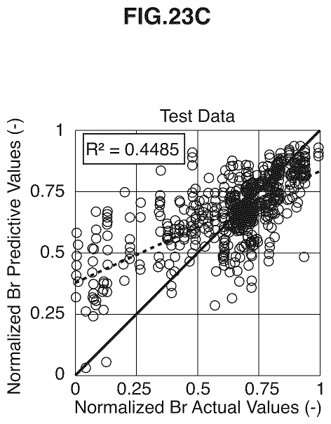

FIG. 23A-23C are graphs showing prediction performance of the learned property prediction model 32 (a regression model) in which the horizontal axis shows actual measurement values of magnetic flux density Br and the vertical axis shows predicted values thereof. Normalization process is performed based on the actual data such that the minimum value is 0 and the maximum value is 1 on both the vertical and horizontal axes. FIG. 23A shows a case in which learning data is used, FIG. 23B shows a case in which validation data is used, and FIG. 23C shows a case in which test data is used. The coefficients of determination R2 of the regression model are: R2=0.9805 for the learning data, R2=0.4286 for the validation data, and R2=0.4485 for the test data. Thus, it can be seen that the property prediction model 32 with excellent prediction performance has been created.

Resuming the description of the flowchart in FIG. 22, the control unit 101 samples the latent variables Z that are to be input into the generative model 31 (the decoder 212) of the image generation/prediction model (a step S201a). The latent variable Z in the present embodiment is any data such as random noise, for example.

The control unit 101 generates the microstructure image (the generated image 51) by the image generation/prediction model with the latent variables Z (any data such as random noise) sampled in the step 201a as an input, and then predicts the process conditions 60 and the material properties 61 for the generated image 51 (a step S202a). The output data of the control unit 101 includes the generated image 51 and the process conditions 60 and the material properties 61 predicted from the generated image 51. The control unit 101 generates a plurality of output data and decides whether the material properties 61 of each output data satisfy aimed conditions (satisfy aimed properties) or not (a step S203a). The control unit 101 also decides whether a predetermined aimed number of images satisfying the aimed properties are obtained or not (a step S204a). If the number of the images satisfying the aimed properties is less than the predetermined aimed number (either the step S203a or the step S204a: NO), the process returns to the step S201a and repeats generating output data by the image generation/prediction model. In a case in which a certain number of aimed images cannot be obtained within effective time, it is effective to return to START and perform parameter tuning.

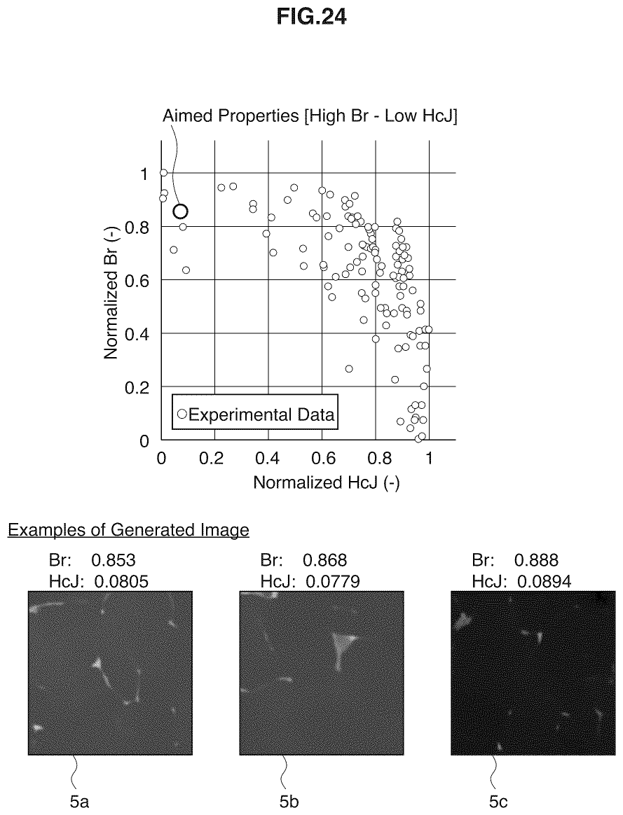

FIG. 24-FIG. 26 show examples of the generated images 51 of rare-earth magnets according to the respective aimed properties.

FIG. 24 shows examples of the generated images 5a, 5b, and 5c for the aimed properties of high Br (magnetic flux density) and low HcJ (coercive force). The aimed conditions are shown in Equation (1) below, in which B_{rpred} represents a predicted value of magnetic flux density and H_{cJpred} represents a predicted value of coercive force.

$$( Equation 1 )$$

$$\sqrt{{( \frac{{H}_{cJ}^{pred} - 0.0837}{0.0837} )}^{2} + {( \frac{{B}_{r}^{pred} - 0.868}{0.868} )}^{2}} < 5 e - 2 \qquad ( 1 )$$

The generated images 5a, 5b, and 5c in FIG. 24 have the same size as the learning data, which is in a rectangular small piece image size. The predicted values for the material properties of the generated image 5a are Br: 0.853 [-] and HcJ: 0.0805 [-]; the predicted values for the material properties of the generated image 5b are Br: 0.868 [-] and HcJ: 0.0779 [-]; and the predicted values for the material properties of the generated image 5c are Br: 0.888 [-] and HcJ: 0.0894 [-].

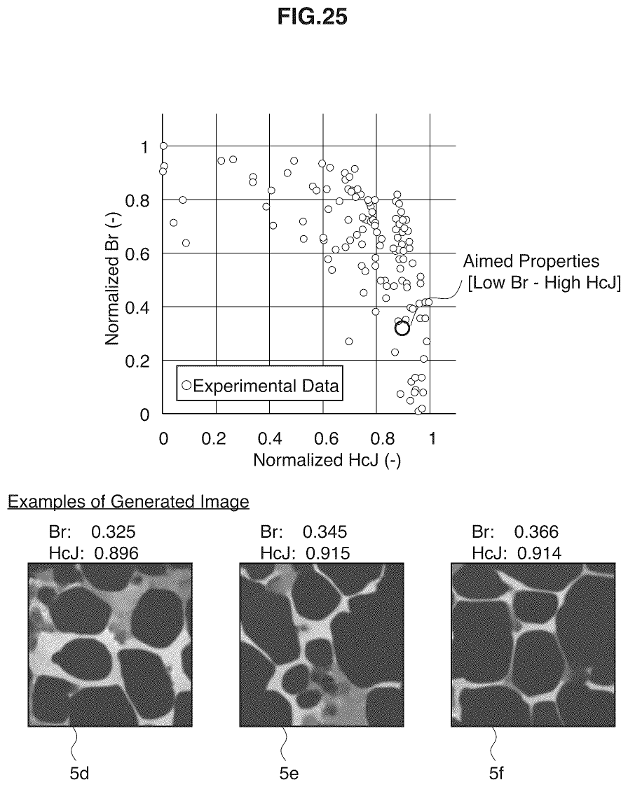

Also, FIG. 25 shows examples of the generated images 5d, 5e, and 5f for the aimed properties of low Br (magnetic flux density) and high HcJ (coercive force). The aimed conditions are shown in Equation (2) below.

$$( Equation 2 )$$

$$\sqrt{{( \frac{{H}_{cJ}^{pred} - 0.91}{0.91} )}^{2} + {( \frac{{B}_{r}^{pred} - 0.36}{0.36} )}^{2}} < 5 e - 2 \qquad ( 2 )$$

In FIG. 25, the predicted values for the material properties of the generated image 5d are Br: 0.325 [-] and HcJ: 0.0896 [-]; the predicted values for the material properties of the generated image 5e are Br: 0.345 [-] and HcJ: 0.915 [-]; and the predicted values for the material properties of the generated image 5f are Br: 0.366 [-] and HcJ: 0.914 [-].

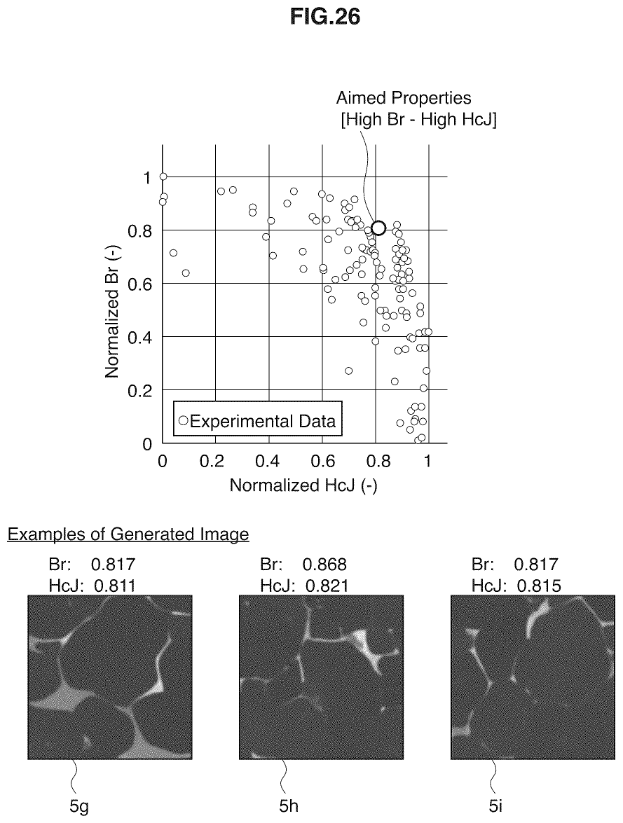

Also, FIG. 26 shows examples of the generated images 5g, 5h, and 5i for the aimed properties of high Br (magnetic flux density) and high HcJ (coercive force). The aimed conditions are shown in Equation (3) below.

$$( Equation 3 )$$

$$\sqrt{{( \frac{{H}_{cJ}^{pred} - 0.783}{0.783} )}^{2} + {( \frac{{B}_{r}^{pred} - 0.868}{0.868} )}^{2}} < 5 e - 2 \qquad ( 3 )$$

In FIG. 26, the predicted values for the material properties of the generated image 5g are Br: 0.817 [-] and HcJ: 0.811 [-]; the predicted values for the material properties of the generated image 5h are Br: 0.868 [-] and HcJ: 0.821 [-]; and the predicted values for the material properties of the generated image 5i are Br: 0.817 [-] and HcJ: 0.815 [-].

Resuming the description of the flowchart in FIG. 22, when the number of the microstructure images 5 satisfying the aimed properties has reached the predetermined aimed number (both the steps S203a and S204a: YES), the control unit 101 then executes a visualization process (a step S205a).

In the visualization process, the control unit 101 displays on the display unit 105 the prediction results of the process conditions 60 and the material properties 61 for the microstructure image 5. The control unit 101 may also display a process condition map or a characteristic map, in which the predicted process conditions 60 or the material properties 61 are plotted in a graph or on the microstructure image 5, or a SHAP distribution map, in which SHAP values are plotted in graphs or on the microstructure image 5.

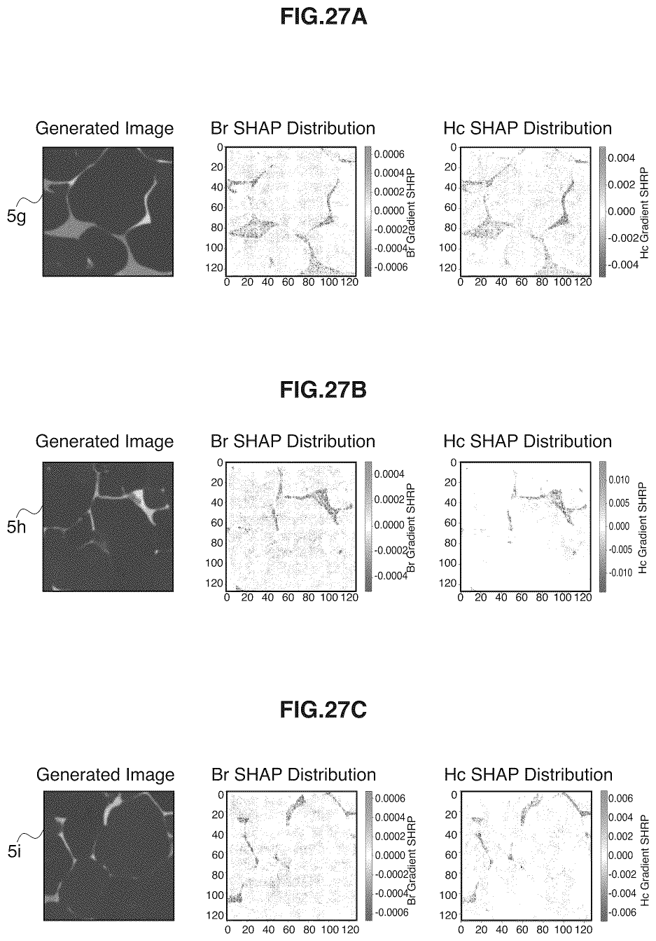

FIG. 27A-FIG. 27C show distribution maps of SHAP values, as one example of the visualization process of the material properties. FIG. 27A shows a magnetic flux density Br SHAP distribution map and a coercive force HcJ SHAP distribution map of the generated image 5g in FIG. 26. FIG. 27B shows a magnetic flux density Br SHAP distribution map and a coercive force HcJ SHAP distribution map of the generated image 5h in FIG. 26. FIG. 27C shows a magnetic flux density Br SHAP distribution map and a coercive force HcJ SHAP distribution map of the generated image 5i in FIG. 26. Visualizing generated images and material properties thereof as above can facilitate evaluation of microstructures and material properties of a material.

As described above, the prediction apparatus 1a of the second embodiment learns the generative model 31 using the microstructure images acquired from the material as learning data, learns the property prediction model 32 using the data that is a pair of the microstructure images of the material and the material properties as learning data, and builds the image generation/prediction model by coupling the generative model 31 with the process property prediction model 32 and the process condition prediction model 33. In this way, process conditions and material properties can be predicted for the generated microstructure image. Also, by acquiring the microstructure image 5 having the aimed material properties from the generated microstructure images and visualizing the microstructure image 5, the process conditions, and the material properties, it is possible to understand the microstructure having the aimed properties or the process conditions for achieving the aimed properties.

Note that, similarly as in the first embodiment, the generated images may be treated with the super-resolution process at the time of image generation (the step S202a in FIG. 22) or at the time of learning the property prediction model 32 and the process condition prediction model 33 (the step S102a in FIG. 22).

### Third Embodiment

Next, a third embodiment will be described. In the second embodiment, the generated images are randomly generated. However, it is efficient to generate more of the generated images having the material properties that are close to the aimed material properties. In the third embodiment, improvements are made on a method of image generation.

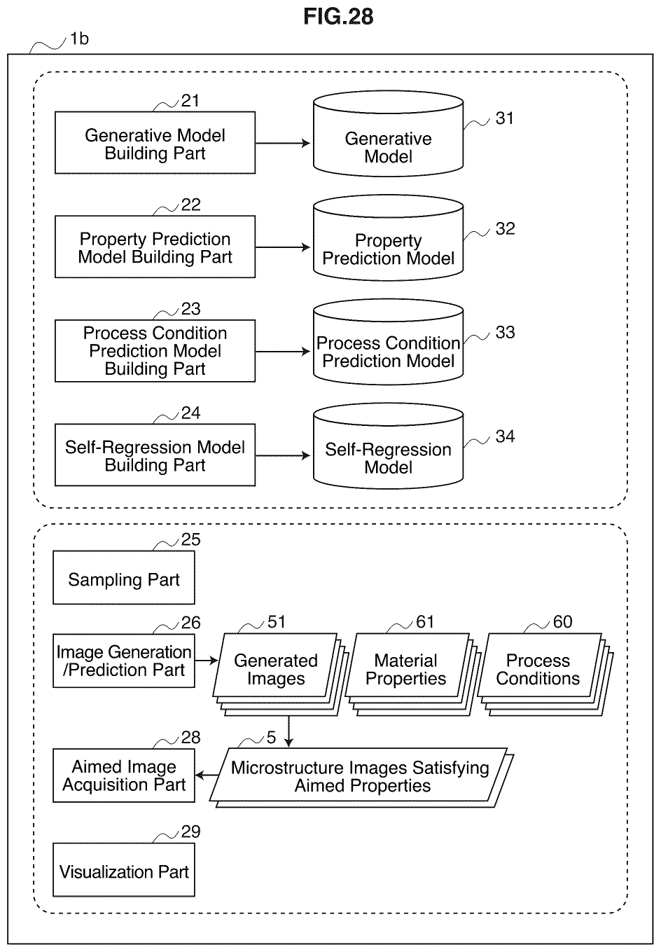

FIG. 28 is a block diagram showing a functional configuration of a prediction apparatus 1b according to the third embodiment. In addition to the configuration of the prediction apparatus 1a (FIG. 18), the prediction apparatus 1b further includes a self-regression model building part 24.

The self-regression model building part 24 learns and builds a self-regression model 34 (conditional probability distribution) based on the latent variables Z obtained by inputting the microstructure images 41 for learning into the learned generative model 31 (the encoder 211).

Learning of the self-regression model 34 will be described. Firstly, a supplementary explanation for the embedding vectors V in VQVAE in FIG. 3 will be given. As shown in FIG. 3, the number of values stored in each of the embedding vectors V is D, and the number of the embedding vectors V existing is K. K and D are hyper parameters, which are set by a user in advance. When learning VQVAE, D number of the values included in each of the embedding vectors V are optimized. As shown in FIG. 3, the latent variables Z can be shown as a two-dimensional array formed by an index of the embedding vectors V. For example, “2” included in the latent variables Z shows an embedded vector V2 of which an index is second.

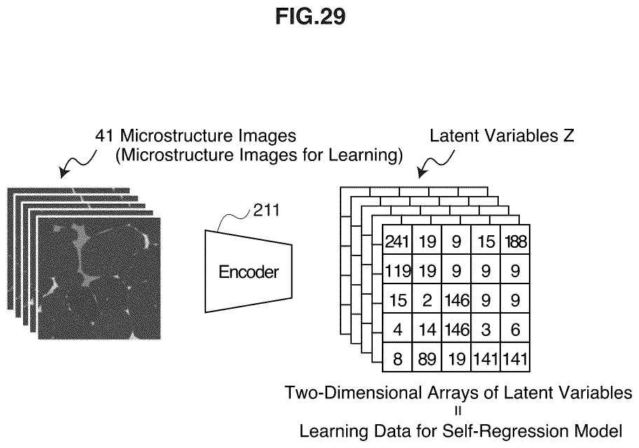

After learning VQVAE in FIG. 3 (after building of the generative model 31), the self-regression model building part 24 enters the microstructure images 41 for learning into the encoder 211 of the learned generative model 31 as shown in FIG. 29 to acquire the two-dimensional arrays of the latent variables Z. The number of the two-dimensional arrays of the latent variables Z acquired is the number of the microstructure images 41 for learning. In the two-dimensional array of the latent variables Z, the indexes are not randomly arranged but are arranged following a certain rule or pattern. The self-regression model building part 24 learns such the rule or pattern by the self-regression model.

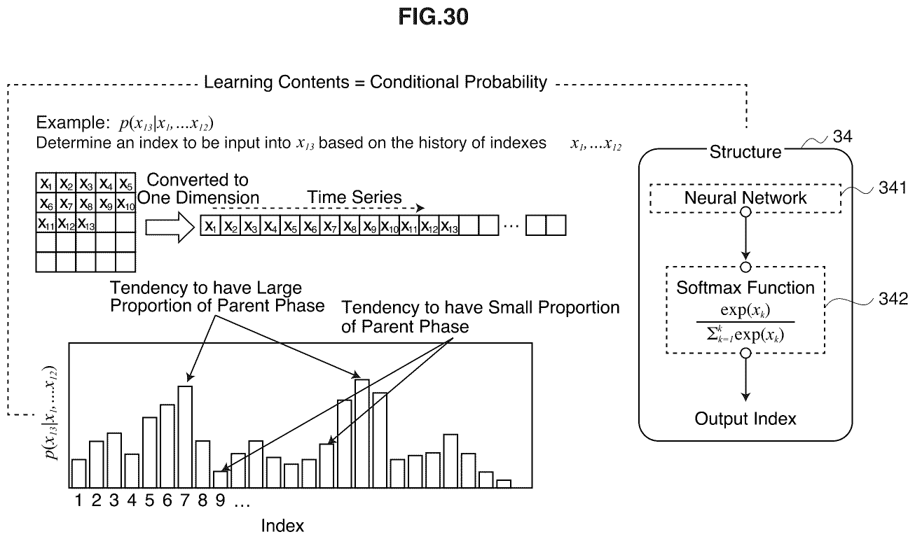

More specifically, the self-regression model building part 24 converts the two-dimensional array of the latent variables Z into a one-dimensional data row as shown in FIG. 30, and, regarding such the data row as a time series, learns the conditional probability distribution (the self-regression model 34) according to a history of the indexes that have been already embedded. As shown in FIG. 30, the self-regression model 34 has a microstructure formed of a neural network 341 and a Softmax function 342, for example.

The sampling part 25 samples the latent variables Z by using the self-regression model 34 (the conditional probability distribution) learned by the self-regression building part 24. More specifically, the index to be input into each array is sampled in turn from the top left corner of the two-dimensional array of the latent variables based on the self-regression model 34 (the conditional probability distribution). At the time of sampling, as shown in the conditional probability distribution shown in FIG. 30, there are indexes with higher probability of inputting into the array as well as indexes with lower probability of inputting into the array.

In the present embodiment in particular, instead of using the learned self-regression model 34 as is, the sampling part 25 samples after adjusting height of peak parts and dip parts of the conditional probability distribution included in the self-regression model 34. This can adjust the probability of the indexes that to be input into the arrays of the latent variables Z.

Although there are depositions, grain boundaries, voids, and the like existing in material microstructures in general, parent phases account for the largest proportion in the material microstructures. Thus, the indexes with high probability of inputting into the array of the latent variables Z (the peak parts of the conditional probability) may tend to include microstructure information with the large proportion of the parent phase. In contrast, the indexes with low probability of inputting into the array of the latent variables Z (the dip parts of the conditional probability) may tend to include microstructure information with the small proportion of the parent phase.

As above, adjusting the height of the peak parts and the dip parts of the conditional probability distribution can adjust the probability of the indexes to enter into the arrays of the latent variables Z, and thus it is possible to generate generated images focusing on specific material microstructures. For example, it is possible to generate more of microstructure images including material microstructures that are strongly related to the aimed material properties, and less of microstructure images including material microstructures that are weakly related to the aimed material properties.

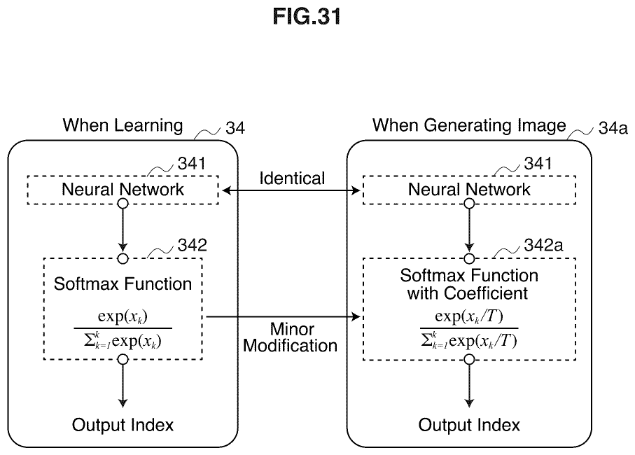

More specifically, as shown in FIG. 31, the sampling part 25 modifies the Softmax function 342 representing the conditional probability distribution to a Softmax function with coefficient 342a added with a coefficient T. The Softmax function with coefficient 342a is expressed as follows.

$$( Equation 4 )$$

$$\frac{exp ( {x}_{k} / T )}{{\sum }_{k = 1}^{k} exp ( {x}_{k} / T )} \qquad ( 4 )$$

Then, the sampling part 25 adjusts the height of the peak parts and the dip parts of the conditional probability distribution by varying the coefficient T of the Softmax function with coefficient 342a, and samples the latent variables Z based on a self-regression model 34a having the adjusted conditional probability distribution (the Softmax function with coefficient 342a).

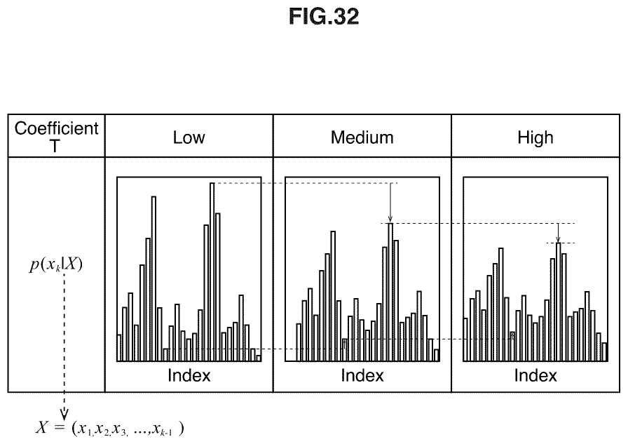

FIG. 32 is a graph showing changes in the function when the coefficient of the Softmax function 342a is varied. As shown in FIG. 32, the larger the coefficient T is, the lower the height of the peak parts of the Softmax function 342a (the conditional probability distribution) is and the higher the height of the dip parts thereof is. As mentioned above, there is a tendency that the peak parts of the conditional probability may include the microstructure information with a large proportion of the parent phases. Thus, if sampling is carried out in a condition in which the coefficient T of the Softmax function 342a is large, the height of the peak parts of the conditional probability distribution decreases and the indexes including the microstructure information with a large proportion of parent phases are hard to appear at the time of image generation. Also, the height of the dip parts of the conditional probability distribution increases and thus the indexes including the microstructure information with a small proportion of parent phases (proportions of grain boundaries, depositions, and voids are larger) are easy to appear. In contrast, if sampling is carried out in a condition in which the coefficient T of the Softmax function 342a is small, the height of the peak parts of the conditional probability distribution decreases and the indexes including the microstructure information with a large proportion of parent phases are easy to appear at the time of image generation. Also, the height of the dip parts of the conditional probability distribution decreases and thus the indexes including the microstructure information with a small proportion of parent phases (proportions of grain boundaries, depositions, and voids are larger) are hard to appear.

The coefficient T can be set appropriately according to the aimed material properties. For example, if high coercive force is an aimed property, grain boundaries are related to coercive force (see FIG. 21) and thus it is efficient to generate more microstructure images having a small proportion of parent phases. That is, it is preferable to set the coefficient T large. When sampling is carried out with the large coefficient T, the height of the dip parts of the conditional probability distribution increases, and thus the indexes including the microstructure information with a small proportion of parent phases (a proportion of grain boundaries is larger) are easy to appear, thereby generating more microstructure images with a small proportion of parent phases (a proportion of grain boundaries is larger). As above, the sampling is carried out after controlling the proportion of parent phases by the coefficient T according to the aimed properties.

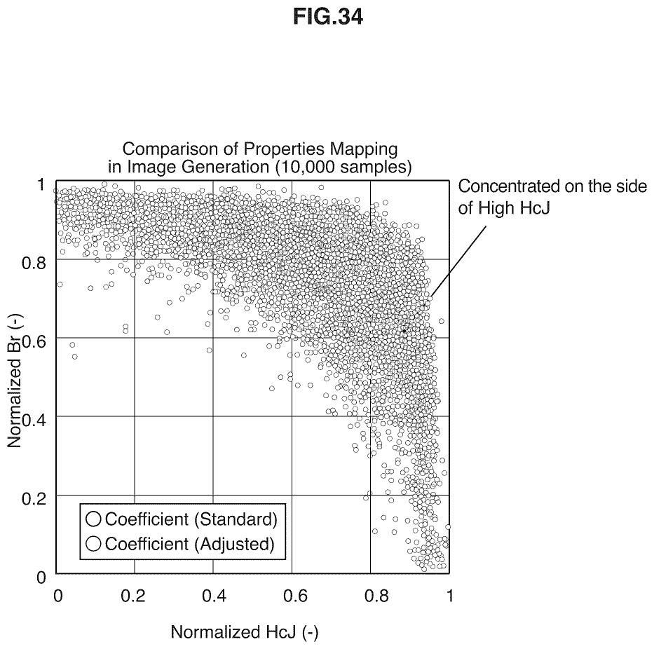

The image generation/prediction part 26 enters the latent variables Z sampled by the sampling part 25 into the decoder 212 of the generative model 31 to generate the generated image 51. Also, the image generation/prediction part 26 predicts the material properties 61 by using the property prediction model 32 and the process conditions 60 by using the process condition prediction model 33 for the generated image 51 that has been generated. Distribution of the material properties 61 of the generated image 51 generated by the image generation/prediction part 26 is not uniform but has deviation (see FIG. 34).

The other parts of the functional configuration of the prediction apparatus 1b (the generative model building part 21, the property prediction model building part 22, the process condition prediction model building part 23, the aimed image acquisition part 28, and the visualization part 29) are the same as the functional microstructure of the prediction apparatus 1a (FIG. 18) and thus descriptions thereof will be omitted. Also, a hardware configuration of the prediction apparatus 1b is the same as the hardware configuration of the prediction apparatus 1 or 1a (FIG. 1).

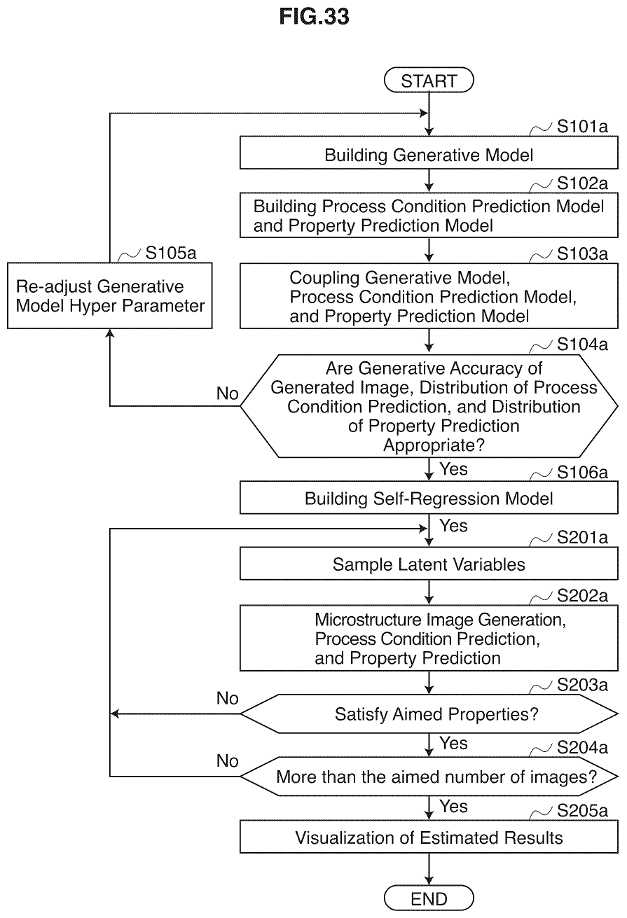

Next, a flow of processes carried out by the prediction apparatus 1b (a method of prediction) will be described with a reference to a flowchart shown in FIG. 33. The control unit 101 of the prediction apparatus 1b executes the process of each step in FIG. 33 to realize each function of the prediction apparatus 1b.

The steps S101a-S105a in FIG. 33 are the same as the steps S101a-S105a in FIG. 22. That is, the control unit 101 learns and builds the generative model 31 such as VQVAE using the microstructure images 41 for learning as learning data. Next, the control unit 101 uses the learning data 43, which is the generated images 51 for learning, which are images of the microstructure images 41 for learning restored (rebuilt) by the generative model 31, paired with process conditions, to learn and build the process condition prediction model 33, and then uses the learning data 42, which is the generated images 51 for learning paired with the material properties, to learn and build the property prediction model 32 (the step S102a). Then, the control unit 101 generates the image generation/prediction model by coupling the generative model 31 built in the step S101a with the process condition prediction model 33 and the property prediction model 32 that have been built in the step S102a (the step S103a).

An operator performs, using validation data and test data, a validation/test on the image generation/prediction model produced in the step S103a to determine whether an accuracy of reconstruction of the generated images 51 generated and distribution of the predicted values of the process conditions 60 and the material properties 61 are suitable or not (the step S104a). If unsuitable (the step S104a: NO), the operator adjusts a hyper parameter of the generative model 31 (the step S105a) and retries building the generative model 31 (the step S101a) and building the process condition prediction model 33 and the property prediction model 32.

If the operator decides that the accuracy of reconstruction the generated image 51 and the distribution of predicted values of the process conditions 60 and the material properties 61 are unsuitable (the step S104a: NO), the operator operates the “ADJUSTMENT” button for transition to the hyper parameter adjusting screen, for example. In such the case, the control unit 101 displays the hyper parameter adjusting screen to receive from the operator an adjustment on the epoch or the like (the step S105a). A function in the step S105a in which the control unit 101 executes “displaying the hyper parameter adjusting screen to receive from the operator an adjustment on the epoch or the like” is one example of “adjusting means” according to the present invention. The adjustment of the hyper parameter may be done not only on the adjusting screen but also by directly correcting a corresponding part of the program. The operator repeats learning, verifying, and testing on the generative model 31, the process condition prediction model 33, and the property prediction model 32 while adjusting the hyper parameter (the steps S101a-S105a). Then, when the operator decides that the accuracy of reconstruction of the generated images 51 generated and the distribution of predicted values of the process conditions 60 and the material properties 61 are suitable (the step S104a: YES), the learning processes are terminated, transitioning to a next step S106a.

In the step S106a, the control unit 101 learns and builds the self-regression model 34 (the conditional probability distribution). More specifically, the control unit 101 firstly enters the microstructure images 41 for learning into the encoder 211 of the learned generative model 31 to acquire two-dimensional arrays of the latent variables Z (FIG. 29). The number of the two-dimensional arrays of the latent variables Z acquired is the number of the microstructure images 41 for learning. Next, the control unit 101 learns the self-regression model 34 based on the acquired latent variables Z. More specifically, the control unit 101 converts the two-dimensional arrays of the latent variables Z into a one-dimensional row of data as shown in FIG. 30 and, regarding such the data row as a time series, learns the conditional probability distribution (the self-regression model 34) according to a history of the indexes that have been already embedded. As shown in FIG. 30, the self-regression model 34 has a microstructure formed of the neural network 341 and the Softmax function 342, for example.

Next, the control unit 101 samples the latent variables Z by using the learned self-regression model 34 (a step S 201a). At this time, instead of sampling the latent variables Z by using the self-regression model 34 as is, the control unit 101 adjusts the conditional probability distribution included in the learned self-regression model 34 and then samples the latent variables Z based on the adjusted conditional probability distribution. More specifically, the control unit 101 firstly modifies the Softmax function 342 representing the conditional probability distribution to the Softmax function with coefficient 342a that is added with the coefficient T. Then, the control unit 101 sets the coefficient T of the Softmax function with coefficient 342a to a predetermined value. This can adjust the heights of the peak and dip parts of the conditional probability distribution included in the self-regression model 34 (FIG. 32). The coefficient T may be set appropriately according to the aimed material properties. Then, the control unit 101 samples the latent variables Z based on the self-regression model 34a having the Softmax function with coefficient 342a with the set coefficient (FIG. 31).

The process hereafter (from the step S202a to the step S205a in FIG. 33) is the same as the process in the second embodiment (from the step S202a to the step S205a in FIG. 22). That is, the control unit 101 generates the microstructure image (the generated image 51) by the image generation/prediction model with the latent variables Z sampled in the step 201 as an input, and then predicts the material properties 61 and the process conditions 60 for the generated image 51 (the step S202a). Next, the control unit 101 generates a plurality of output data and decides whether the material properties 61 of each output data satisfy aimed conditions (satisfy aimed properties) or not (the step S203a). The control unit 101 also decides whether a predetermined aimed number of images satisfying the aimed properties are obtained or not (the step S204a). If the number of the images satisfying the aimed properties is less than the predetermined aimed number (either the step S203a or the step S204a: NO), the process returns to the step S201a and repeats the generation of output data by the image generation/prediction model. When the number of the microstructure images 5 satisfying the aimed properties has reached the predetermined aimed number (both the steps S203a and S204a: YES), the control unit 101 then executes a visualization process (the step S205a) and terminates the process. In the visualization process, the control unit 101 displays on the display unit 105 the prediction results of the process conditions 60 and the material properties 61 of the microstructure image 5 that satisfies the aimed properties.

FIG. 34 is a graph showing distribution of the material properties when the coefficient T is adjusted. The white dots plotted represent prediction results of the material properties when generated images are generated after sampling the latent variables Z with a standard value of the coefficient T of the Softmax function with coefficient 342a of the regression model 34a. The black dots plotted represent prediction results of the material properties when generated images are generated after sampling the latent variables Z with a predetermined value larger than the standard value of the coefficient T of the Softmax function with coefficient 342a of the regression model 34a. From FIG. 34, it can be seen that the distribution of the material properties is deviated toward the higher coercive force side for the black dots with the large coefficient T. Thus, by adjusting the coefficient T in this way, it is possible to generate more of generated images having properties that are closer to the aimed properties (“high coercive force” in the case of FIG. 25).

As above, the third embodiment has been described. According to the third embodiment, the latent variables Z are obtained by inputting the microstructure images 41 for learning into the generative model 31 (the encoder 211), the self-regression model 34 is learned based on the latent variables Z, and the latent variables Z are then sampled based on the conditional probability distribution included in the self-regression model 34 to generate microstructure images. At this time, the latent variables Z are sampled after adjusting the heights of the peak and dip parts of the conditional probability distribution, thereby efficiently generating the microstructure images having characteristics that are close to the aimed material properties. In this way, it is possible to develop a material having aimed material properties efficiently.

Note that, similarly as in the first and second embodiments, the generated images may be treated with the super-resolution process at the time of image generation (the step S202a in FIG. 33) or at the time of learning the property prediction model 32 and the process condition prediction model 33 (the step S102a in FIG. 33).

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the present application, and it will be understood that they naturally belong to the technical scope of the present invention.

### DESCRIPTION OF NOTATIONS

1, 1a, 1b prediction apparatus
21 generative model building part
22 property prediction model building part
23 process condition prediction model building part
24 self-regression model building part
25 sampling part
26 image generation/prediction part
28 aimed image acquisition part
29 visualization part
31 generative model
32 properties prediction model
33 process condition prediction model
34 self-regression model
341 neural network
342 Softmax function
342a Softmax function with coefficient
41 microstructure image (actual data)
42 data of material properties paired with microstructure image
43 data of process condition paired with microstructure image
51 microstructure image (generated image)
60 process condition
61 material properties
5 microstructure image having aimed properties

1. A prediction apparatus comprising:
a generative model building part that uses microstructure images, which are acquired from a material, as learning data to build a generative model for generating a microstructure image of the material;
a process condition prediction model building part that builds a process condition prediction model by learning data of process conditions paired with the microstructure images of the material, the process condition prediction model being a regression model for predicting process conditions for any microstructure images; and
an image generation/prediction part that generates a microstructure image of a material by inputting sampled latent variables into the generative model built by the generative model building part, and enters the generated microstructure image of the material into the process condition prediction model built by the process condition prediction model building part so as to generate a microstructure image of the material and, at the same time, predict process conditions for the microstructure image.

2. The prediction apparatus according to claim 1, wherein
epochs for the generative model building part and the process condition prediction model building part are decided based on an accuracy of reconstruction of microstructure images generated by the generative model and distribution of process conditions predicted by the process condition prediction model.

3. The prediction apparatus according to claim 2, the prediction apparatus further comprising:
adjusting means for adjusting the epochs for the generative model building part and the process condition prediction model building part.

4. The prediction apparatus according to claim 1, wherein
the image generation/prediction part enters an image obtained by applying super-resolution process on the microstructure image of the material generated by the generative model into the process condition prediction model to predict process conditions.

5. The prediction apparatus according to claim 1, wherein
the process condition prediction model building part uses, as the microstructure image of the material to be learned, an image obtained by applying super-resolution process on the image rebuilt from the microstructure image of the material by the generative model.

6. The prediction apparatus according to claim 1, the prediction apparatus further comprising:
a property prediction model building part that builds a property prediction model, which is a regression model that predicts material properties of any microstructure images by learning data of material properties paired with the microstructure images of the material, wherein
the image generation/prediction part predicts material properties of the microstructure image of the material generated by using the property prediction model.

7. The prediction apparatus according to claim 6, the prediction apparatus further comprising:
an aimed image acquisition part that acquires, from microstructure images of the material generated by the image generation/prediction part, a microstructure image of the material having aimed material properties.

8. The prediction apparatus according to claim 7, wherein
the aimed image acquisition part decides whether the material properties, which are predicted by the image generation/prediction part, of the microstructure image generated by the generative model satisfy predetermined aimed conditions or not; and
if the material properties satisfy the predetermined aimed conditions, the generated microstructure image is taken as the microstructure image of the material having the aimed material properties.

9. The prediction apparatus according to claim 8, the prediction apparatus further comprising:
a visualization part that visualizes prediction results of the process conditions and the material properties of the microstructure image of the material having the aimed material properties.

10. The prediction apparatus according to claim 6, wherein
epochs for the generative model building part and the property prediction model building part are decided based on an accuracy of reconstruction of microstructure images generated by the generative model and distribution of material properties predicted by the property prediction model.

11. The prediction apparatus according to claim 10, the prediction apparatus further comprising:
adjusting means for adjusting the epochs for the generative model building part and the property prediction model building part.

12. The prediction apparatus according to claim 6, wherein
the image generation/prediction part enters an image obtained by applying super-resolution process on the microstructure image of the material generated by the generative model into the property prediction model to predict material properties.

13. The prediction apparatus according to claim 6, wherein
the property prediction model building part uses, as the microstructure image of the material to be learned, an image obtained by applying super-resolution process on the image rebuilt from the microstructure image of the material by the generative model.

14. The prediction apparatus according to claim 6, wherein
the image generation/prediction part generates more microstructure images that includes microstructures strongly related to the aimed material properties, or less microstructure images that includes microstructures weakly related to the aimed material properties, than in a case in which microstructure images are randomly generated.

15. The prediction apparatus according to claim 6, wherein
distribution of the material properties of microstructure images generated by the image generation/prediction part has deviation.

16. A prediction method run on a computer, the method comprising steps of:
building a generative model by using microstructure images, which are acquired from images of a material, as learning data to build a generative model for generating a microstructure image of the material;
building a process condition prediction model, which is a regression model for predicting process conditions for any microstructure images, by learning data of process conditions paired with the microstructure images of the material; and
generating a microstructure image of the material by inputting sampled latent variables into the generative model built in the step of building the generative model, and inputting the generated microstructure image of the material into the process condition prediction model built in the step of building the process condition prediction model so as to generate the microstructure image of the material and, at the same time, to predict process conditions for the microstructure image.

17. A storage medium for storing a program that causes a computer to function as
a generative model building part that uses microstructure images, which are acquired from a material, as learning data to build a generative model for generating a microstructure image of the material;
a process condition prediction model building part that builds a process condition prediction model, which is a regression model for predicting process conditions for any microstructure images, by learning data of process conditions paired with the microstructure images of the material; and
an image generation/prediction part that generates a microstructure image of a material by inputting sampled latent variables into the generative model that is built by the generative model building part and enters the generated microstructure image of the material into the process condition prediction model that is built by the process condition prediction model building part so as to generate a microstructure image of the material and, at the same time, predicts process conditions for the microstructure image.
